(19) United States
(12) Patent Application Publication
(10) Pub. No.: US 2023/0169997 A1
(43) Pub. Date: Jun. 1, 2023

(54) MAGNETIC RECORDING AND REPRODUCING DEVICE

(71) Applicant: FUJIFILM Corporation, Tokyo (JP)

(72) Inventors: Megumi NAKANO, Minamiashigara-shi (JP); Yuto MURATA, Minamiashigara-shi (JP)

(73) Assignee: FUJIFILM Corporation, Tokyo (JP)

(21) Appl. No.: 18/160,614

(22) Filed: Jan. 27, 2023

Related U.S. Application Data
(63) Continuation of application No. PCT/JP21/28015, filed on Jul. 29, 2021.

(30) Foreign Application Priority Data
Jul. 31, 2020 (JP) 2020-130866

(51) Int. Cl. G11B 33/14

(52) U.S. Cl. CPC G11B 33/1453

(57) ABSTRACT

Provided is a magnetic recording and reproducing device including, in a sealed space in the magnetic recording and reproducing device: a magnetic tape; and a magnetic head are provided, in which a relative humidity difference (RH_{C}-RH_{B}) between a relative humidity RH_{B} in the sealed space measured in an environment of a temperature of 21° C. and a relative humidity of 50% and a relative humidity RH_{C} in the sealed space measured in an environment of a temperature of 60° C. and a relative humidity of 5% is within ±10%.

### CROSS-REFERENCE TO RELATED APPLICATIONS

This application is a Continuation of PCT International Application No. PCT/JP2021/028015 filed on Jul. 29, 2021, which claims priority under 35 U.S.C. § 119(a) to Japanese Patent Application No. 2020-130866 filed on Jul. 31, 2020. Each of the above applications is hereby expressly incorporated by reference, in its entirety, into the present application.

### BACKGROUND OF THE INVENTION

### 1. Field of the Invention

The present invention relates to a magnetic recording and reproducing device.

### 2. Description of the Related Art

There are two types of magnetic recording media: a tape shape and a disk shape, and a tape-shaped magnetic recording medium, that is, a magnetic tape is mainly used for data storage applications such as data backup and archiving (for example, see U.S. Ser. No. 10/559,328B and JP1994-203546A (JP-H6-203546A).

### SUMMARY OF THE INVENTION

Recording of data on a magnetic tape is usually performed by inserting a magnetic tape cartridge in which the magnetic tape is accommodated into a magnetic recording and reproducing device (generally referred to as a “drive”), running the magnetic tape between a reel of the magnetic tape cartridge and a winding reel built in the magnetic recording and reproducing device, and causing a magnetic head to follow a data band of the magnetic tape to record data on the data band. Thereby, a data track is formed in the data band. In addition, in a case where the recorded data is reproduced, usually, the magnetic tape is run between the reel of the magnetic tape cartridge and the winding reel built in the magnetic recording and reproducing device, and the magnetic head is caused to follow the data band of the magnetic tape to read the recorded data on the data band.

During the recording and/or reproduction is performed, in a case where the magnetic head for recording and/or reproducing data records and/or reproduces data while being deviated from a target track position due to deformation (in particular, a change in tape width dimension) of the magnetic tape, a phenomenon such as recording failure (for example, overwriting of recorded data) or reproduction failure (for example, data reading failure) may occur. On the other hand, in recent years, there has been an increasing need for narrowing a track width of the data track in order to increase a capacity of the magnetic tape. However, the narrower the track width, the more likely above-described phenomenon is to be apparent. Therefore, it is expected that further efforts will be made to suppress the occurrence of the above-described phenomenon in recording and/or reproduction.

In view of the above, an object of an aspect of the present invention is to provide means for enabling favorable recording and/or reproduction on a magnetic tape.

An aspect of the present invention relates to a magnetic recording and reproducing device comprising, in a sealed space in the magnetic recording and reproducing device: a magnetic tape; and a magnetic head, in which a relative humidity difference (RH_{C}-RH_{B}) between a relative humidity RH_{B} in the sealed space measured in an environment of a temperature of 21° C. and a relative humidity of 50% and a relative humidity RH_{C} in the sealed space measured in an environment of a temperature of 60° C. and a relative humidity of 5% is within ±10%. The above-mentioned “RH” is an abbreviation for reactive humanity.

In one embodiment, the relative humidity difference (RH_{C}-RH_{B}) may be within ±5%.

In one embodiment, the magnetic recording and reproducing device may further comprise, in the sealed space: a humidity sensor.

In one embodiment, the magnetic tape may include a non-magnetic support and a magnetic layer having a ferromagnetic powder.

In one embodiment, the ferromagnetic powder may be a hexagonal barium ferrite powder.

In one embodiment, the ferromagnetic powder may be a hexagonal strontium ferrite powder.

In one embodiment, the ferromagnetic powder may be an ε-iron oxide powder.

In one embodiment, the magnetic tape may further comprise a non-magnetic layer including a non-magnetic powder between the non-magnetic support and the magnetic layer.

In one embodiment, the magnetic tape may further comprise a back coating layer containing a non-magnetic powder on a surface side of the non-magnetic support opposite to a surface side on which the magnetic layer is provided.

In one embodiment, a tape thickness of the magnetic tape may be 5.6 μm or less.

In one embodiment, a tape thickness of the magnetic tape may be 5.2 μm or less.

According to an aspect of the present invention, it is possible to satisfactorily record and/or reproduce data on the magnetic tape.

### BRIEF DESCRIPTION OF THE DRAWINGS

FIG. 1 shows an arrangement example of a data band and a servo band.

FIG. 2 shows an arrangement example of a servo pattern of a linear tape-open (LTO) Ultrium format tape.

FIG. 3 shows a configuration example of a magnetic recording and reproducing device.

FIG. 4 shows another configuration example of the magnetic recording and reproducing device.

### DESCRIPTION OF THE PREFERRED EMBODIMENTS

An aspect of the present invention relates to a magnetic recording and reproducing device. The magnetic recording and reproducing device includes a magnetic tape and a magnetic head in a sealed space in the magnetic recording and reproducing device. A relative humidity difference (RH_{C}-RH_{B}) between a relative humidity RH_{B} in the sealed space measured in an environment of a temperature of 21° C. and a relative humidity of 50% and a relative humidity RH_{C} in the sealed space measured in an environment of a temperature of 60° C. and a relative humidity of 5% is within ±10%.

In the present invention and the present specification, the term “magnetic recording and reproducing device” means a device capable of performing one or both of recording of data on the magnetic tape and reproducing of data recorded on the magnetic tape.

As described above, during the recording and/or reproduction is performed, in a case where the magnetic head for recording and/or reproducing data records and/or reproduces data while being deviated from a target track position due to deformation (in particular, a change in tape width dimension) of the magnetic tape, a phenomenon such as recording failure or reproduction failure may occur. It is considered that the deformation of the magnetic tape, which is a cause of this phenomenon, occurs due to an environmental change, such as an environmental change between the recording and reproduction, an environmental change between the former recording and the latter recording, or an environmental change between the former reproduction and the latter reproduction. Regarding the environmental change, U.S. Ser. No. 10/559,328B described above proposes that an environment in a data storage library is controlled by individual air conditioning for each library. However, in order to perform such control, a large amount of cost is required due to the introduction of a large-scale facility, an increase in power consumption, and the like.

Incidentally, in a magnetic recording and reproducing device using a magnetic tape as a magnetic recording medium, a magnetic head is usually built in the magnetic recording and reproducing device, while the magnetic tape is treated as a removable medium (so-called a replaceable medium). After a magnetic tape cartridge in which the magnetic tape is accommodated is inserted into a magnetic recording and reproducing device and the magnetic tape is run between a reel of the magnetic tape cartridge and a winding reel built in the magnetic recording and reproducing device to perform recording of data on the magnetic tape and/or reproduction of data recorded on the magnetic tape, the magnetic tape is extracted from the magnetic recording and reproducing device together with the magnetic tape cartridge while being accommodated in the magnetic tape cartridge.

The present inventor has conducted intensive studies with respect to the above point, and as a result, it has been newly found that it is possible to suppress the tape deformation (for example, a change in tape width) caused by the environmental change by accommodating the magnetic tape in a sealed space in the magnetic recording and reproducing device together with the magnetic head and reducing a humidity change in the sealed space. JP1994-203546A (JP-H6-203546A) described above proposes that a magnetic head and a magnetic recording medium are sealed in a housing (claim 1 and the like of JP1994-203546A (JP-H6-203546A)), but does not suggest that a humidity change in the housing has to be suppressed.

Hereinafter, the magnetic recording and reproducing device will be further described in detail.

[Sealed Space]

In the magnetic recording and reproducing device, the magnetic tape and the magnetic head are accommodated in a sealed space in the magnetic recording and reproducing device. In the present invention and the present specification, the term “sealed space” refers to a space in which a degree of sealing evaluated by a dipping method (bombing method) using helium (He) specified in JIS Z 2331:2006 helium leakage test method is 10×10⁻⁸ Pa·m³/sec or less. The degree of sealing of the sealed space may be, for example, 5×10⁻⁹ Pa·m³/sec or more and 10×10⁻⁸ Pa·m³/sec or less, or may be less than the above range. In one aspect, the entire space in a housing can be the sealed space, and in another aspect, a part of the space in a housing can be the sealed space.

The sealed space can be an internal space of the housing that covers the whole or a part of the magnetic recording and reproducing device. The material and shape of the housing are not particularly limited, and can be, for example, the same as the material and shape of the housing of a normal magnetic recording and reproducing device. As an example, metal, resin, or the like can be used as the material of the housing.

[Relative Humidity Difference in Sealed Space (RH_{C}-RH_{B})]

A relative humidity difference (RH_{C}-RH_{B}) measured in the sealed space is within ±10%, that is, in a range of −10% to +10%. The present inventor considers that the accommodation of the magnetic tape in the sealed space where a humidity change is small even due to the difference in the environment makes it possible to suppress the tape deformation (for example, a change in tape width) caused by the environmental change described above, and thus to satisfactorily record and/or reproduce data on the magnetic tape. From the viewpoint of enabling more favorable recording and/or reproduction, the relative humidity difference (RH_{C}-RH_{B}) is preferably within ±9%, and is more preferably within ±8%, ±7%, ±6%, ±5%, ±4%, and ±3% in this order. The relative humidity difference (RH_{C}-RH_{B}) can be 0%, 0% or more, more than 0%, and ±1% or more, and the smaller the value, the more preferable from the viewpoint of enabling more favorable recording and/or reproduction.

The relative humidity difference in the sealed space is measured by the following method.

The magnetic recording and reproducing device as a whole is placed in an environment of an atmosphere temperature of 21° C. and a relative humidity of 50% for 24 hours or longer to acclimate to the same environment, and then the humidity in the sealed space in the magnetic recording and reproducing device is measured in the same environment. The relative humidity measured in this way is a relative humidity RH_{B}.

After the measurement, the magnetic recording and reproducing device as a whole is placed in an environment of an atmosphere temperature of 60° C. and a relative humidity of 5% for 24 hours or longer to acclimate to the same environment, and then the humidity in the sealed space in the magnetic recording and reproducing device is measured in the same environment. The relative humidity measured in this way is a relative humidity RH_{C}.

The relative humidity difference (RH_{C}-RH_{B}) is calculated from the relative humidities RH_{B} and RH_{C} measured in this way.

The present inventor considers that the accommodation of the magnetic tape in the sealed space where a humidity change is small even in a case where the magnetic tape is exposed to such a large environmental change makes it possible to suppress the tape deformation (for example, a change in tape width) caused by the environmental change described above. The temperature and humidity of the environment in which the measurement is performed are examples of a large environmental change, and the temperature and humidity of the environment in which the above magnetic recording and reproducing device is used and stored are not limited to the above-described temperature and humidity.

The measurement of the humidity in the sealed space can be performed using, for example, a humidity sensor disposed in the sealed space. As the humidity sensor, a well-known humidity sensor capable of measuring the humidity in the space and transmitting a result of the measurement to an outside can be used. In addition, as the humidity sensor, a temperature/humidity sensor capable of measuring the temperature in addition to the humidity can be used.

The fact that the magnetic tape is accommodated in the sealed space together with the magnetic head can contribute to facilitating control of the humidity environment in the vicinity of the magnetic tape, unlike the magnetic recording and reproducing device in the related art, which treats the magnetic tape as a replaceable medium. In addition, the present inventor considers that by forming a sealed space, a non-magnetic support, which will be described in detail below, can contribute to maintaining the relative humidity in the sealed space constant by absorbing and/or releasing moisture.

The following means can also be exemplified as means for controlling the relative humidity difference in the sealed space.

The temperature and/or humidity of an environment in which a sealing step of sealing a space is performed to form the sealed space (hereinafter, referred to as an “ambient environment during sealing”) is controlled. The ambient environment during sealing is preferably an environment of an atmosphere temperature of 16° C. or higher, more preferably 20° C. or higher, still more preferably 30° C. or higher, and still more preferably in a range of 30° C. to 50° C. The relative humidity of the ambient environment during sealing is preferably 70% or less, and is more preferably 60% or less. The relative humidity of the ambient environment during sealing can be, for example, in a range of 10% to 60%. The sealing step is preferably performed after a space to be sealed is allowed to fully acclimatize to the ambient environment during sealing (for example, after being placed in the same environment for 10 days or more).

A humidifying agent is placed in the sealed space. As the humidifying agent, for example, a commercially available product can be used. Specific examples of a commercially available humidifying agent include ECOCARAT manufactured by LIXIL Corporation, DRYKEEPER manufactured by Furukawa Electric Co., Ltd., and BELLSUNNY dry manufactured by Teijin Limited. Note that the humidifying agent that can be used is not limited to these.

[Magnetic Tape]

In the magnetic recording and reproducing device, the magnetic tape accommodated in the sealed space can be a magnetic tape including a non-magnetic support and a magnetic layer containing a ferromagnetic powder.

<Non-Magnetic Support>

Examples of the non-magnetic support (hereinafter, simply referred to as a “support”) include well-known components such as polyethylene terephthalate, polyethylene naphthalate, polyamide, polyamideimide, and aromatic polyamide subjected to biaxial stretching.

In one aspect, the non-magnetic support of the magnetic tape can be an aromatic polyester support. In the present invention and the present specification, the term “aromatic polyester” means a resin containing an aromatic skeleton and a plurality of ester bonds, and the “aromatic polyester support” means a support containing at least one aromatic polyester film. The term “aromatic polyester film” refers to a film in which a component that accounts for the largest amount on a mass basis among components constituting the film is an aromatic polyester. The term “aromatic polyester support” in the present invention and the present specification includes those in which all resin films contained in the support are aromatic polyester films, and those containing the aromatic polyester film and another resin film. Specific aspects of the aromatic polyester support include a single-layer aromatic polyester film, a laminated film of two or more aromatic polyester films having the same constituent components, a laminated film of two or more aromatic polyester films having different constituent components, a laminated film including one or more aromatic polyester films and one or more resin films other than the aromatic polyester film, and the like. An adhesive layer or the like may be optionally included between two adjacent layers in the laminated film. The aromatic polyester support may optionally include a metal film and/or a metal oxide film formed on one or both surfaces by vapor deposition or the like. The same applies to a “polyethylene terephthalate support” in the present invention and the present specification.

An aromatic ring contained in the aromatic skeleton of the aromatic polyester is not particularly limited. Specific examples of the aromatic ring include a benzene ring and a naphthalene ring.

For example, polyethylene terephthalate (PET) is a polyester containing a benzene ring, and is a resin obtained by polycondensing ethylene glycol with terephthalic acid and/or dimethyl terephthalate. The term “polyethylene terephthalate” in the present invention and the present specification includes those having a structure having one or more other components (for example, a copolymer component, a component introduced into a terminal or a side chain, or the like) in addition to the above component.

In one aspect, the magnetic tape can include a polyethylene terephthalate support as a non-magnetic support.

The non-magnetic support may be a biaxially stretched film, and may be a film that has been subjected to corona discharge, a plasma treatment, an easy-bonding treatment, a heat treatment, or the like.

<Magnetic Layer>

(Ferromagnetic Powder)

As a ferromagnetic powder contained in the magnetic layer, a well-known ferromagnetic powder as a ferromagnetic powder used in magnetic layers of various magnetic recording media can be used alone or in combination of two or more. From the viewpoint of improving recording density, it is preferable to use a ferromagnetic powder having a small average particle size. From this point, the average particle size of the ferromagnetic powder is preferably 50 nm or less, more preferably 45 nm or less, still more preferably 40 nm or less, still more preferably 35 nm or less, still more preferably 30 nm or less, still more preferably 25 nm or less, and still more preferably 20 nm or less. On the other hand, from the viewpoint of the magnetization stability, the average particle size of the ferromagnetic powder is preferably 5 nm or more, more preferably 8 nm or more, still more preferably 10 nm or more, still more preferably 15 nm or more, and still more preferably 20 nm or more.

Hexagonal Ferrite Powder

Preferred specific examples of the ferromagnetic powder include a hexagonal ferrite powder. For details of the hexagonal ferrite powder, descriptions disclosed in paragraphs 0012 to 0030 of JP2011-225417A, paragraphs 0134 to 0136 of JP2011-216149A, paragraphs 0013 to 0030 of JP2012-204726A, and paragraphs 0029 to 0084 of JP2015-127985A can be referred to, for example.

In the present invention and the present specification, the term “hexagonal ferrite powder” refers to a ferromagnetic powder in which a hexagonal ferrite type crystal structure is detected as a main phase by X-ray diffraction analysis. The main phase refers to a structure to which the highest intensity diffraction peak in an X-ray diffraction spectrum obtained by X-ray diffraction analysis is attributed. For example, in a case where the highest intensity diffraction peak is attributed to a hexagonal ferrite type crystal structure in an X-ray diffraction spectrum obtained by X-ray diffraction analysis, it is determined that the hexagonal ferrite type crystal structure is detected as the main phase. In a case where only a single structure is detected by X-ray diffraction analysis, this detected structure is taken as the main phase. The hexagonal ferrite type crystal structure includes at least an iron atom, a divalent metal atom, and an oxygen atom, as a constituent atom. The divalent metal atom is a metal atom that can be a divalent cation as an ion, and examples thereof may include an alkaline earth metal atom such as a strontium atom, a barium atom, and a calcium atom, and a lead atom. In the present invention and the present specification, a hexagonal strontium ferrite powder refers to a powder in which a main divalent metal atom is a strontium atom, and a hexagonal barium ferrite powder refers to a powder in which a main divalent metal atom is a barium atom. The main divalent metal atom refers to a divalent metal atom that accounts for the most on atom % basis in the divalent metal atom included in the powder. Note that a rare earth atom is not included in the above divalent metal atom. The “rare earth atom” in the present invention and the present specification is selected from the group consisting of a scandium atom (Sc), an yttrium atom (Y), and a lanthanoid atom. The lanthanoid atom is selected from the group consisting of a lanthanum atom (La), a cerium atom (Ce), a praseodymium atom (Pr), a neodymium atom (Nd), a promethium atom (Pm), a samarium atom (Sm), a europium atom (Eu), a gadolinium atom (Gd), a terbium atom (Tb), a dysprosium atom (Dy), a holmium atom (Ho), an erbium atom (Er), a thulium atom (Tm), an ytterbium atom (Yb), and a lutetium atom (Lu).

Hereinafter, the hexagonal strontium ferrite powder, which is an aspect of the hexagonal ferrite powder, will be described in more detail.

An activation volume of the hexagonal strontium ferrite powder is preferably in a range of 800 to 1600 nm³. The finely granulated hexagonal strontium ferrite powder having an activation volume in the above range is suitable for producing a magnetic tape exhibiting excellent electromagnetic conversion characteristics. The activation volume of the hexagonal strontium ferrite powder is preferably 800 nm³ or more, and may be, for example, 850 nm³ or more. Further, from the viewpoint of further improving the electromagnetic conversion characteristics, the activation volume of the hexagonal strontium ferrite powder is more preferably 1500 nm³ or less, still more preferably 1400 nm³ or less, still more preferably 1300 nm³ or less, still more preferably 1200 nm³ or less, and still more preferably 1100 nm³ or less. The same applies to an activation volume of the hexagonal barium ferrite powder.

The term “activation volume” refers to a unit of magnetization reversal and is an index indicating the magnetic size of a particle. An activation volume described in the present invention and the present specification and an anisotropy constant Ku which will be described below are values obtained from the following relational expression between a coercivity Hc and an activation volume V, by performing measurement in a coercivity Hc measurement portion at a magnetic field sweep rate of 3 minutes and 30 minutes using a vibrating sample magnetometer (measurement temperature: 23° C.±1° C.). For a unit of the anisotropy constant Ku, 1 erg/cc=1.0×10⁻¹ J/m³.

Hc=2Ku/Ms{1−[(kT/KuV)In(At/0.693)]^{1/2}}

[In the above expression, Ku: anisotropy constant (unit: J/m³), Ms: saturation magnetization (unit: kA/m), k: Boltzmann constant, T: absolute temperature (unit: K), V: activation volume (unit: cm³), A: spin precession frequency (unit: s⁻¹), t: magnetic field reversal time (unit: s)]

The anisotropy constant Ku can be used as an index for reducing thermal fluctuation, in other words, for improving the thermal stability. The hexagonal strontium ferrite powder preferably has Ku of 1.8×10⁵ J/m³ or more, and more preferably has Ku of 2.0×10⁵ J/m³ or more. Ku of the hexagonal strontium ferrite powder may be, for example, 2.5×10⁵ J/m³ or less. Note that since higher Ku means higher thermal stability, which is preferable, a value thereof is not limited to the values exemplified above.

The hexagonal strontium ferrite powder may or may not include a rare earth atom. In a case where the hexagonal strontium ferrite powder includes a rare earth atom, it is preferable to include a rare earth atom at a content (bulk content) of 0.5 to 5.0 atom % with respect to 100 atom % of an iron atom. In one aspect, the hexagonal strontium ferrite powder including a rare earth atom may have a rare earth atom surface layer portion uneven distribution property. In the present invention and the present specification, the “rare earth atom surface layer portion uneven distribution property” means that a rare earth atom content with respect to 100 atom % of an iron atom in a solution obtained by partially dissolving the hexagonal strontium ferrite powder with an acid (hereinafter, referred to as a “rare earth atom surface layer portion content” or simply a “surface layer portion content” for a rare earth atom) and a rare earth atom content with respect to 100 atom % of an iron atom in a solution obtained by totally dissolving the hexagonal strontium ferrite powder with an acid (hereinafter, referred to as a “rare earth atom bulk content” or simply a “bulk content” for a rare earth atom) satisfy a ratio of a rare earth atom surface layer portion content/a rare earth atom bulk content >1.0. A rare earth atom content in the hexagonal strontium ferrite powder described below is synonymous with the rare earth atom bulk content. On the other hand, partial dissolution using an acid dissolves a surface layer portion of a particle constituting the hexagonal strontium ferrite powder, and thus, a rare earth atom content in a solution obtained by partial dissolution is a rare earth atom content in a surface layer portion of a particle constituting the hexagonal strontium ferrite powder. A rare earth atom surface layer portion content satisfying a ratio of “rare earth atom surface layer portion content/rare earth atom bulk content >1.0” means that in a particle constituting the hexagonal strontium ferrite powder, rare earth atoms are unevenly distributed in a surface layer portion (that is, more than an inside). The surface layer portion in the present invention and the present specification means a partial region from a surface of a particle constituting the hexagonal strontium ferrite powder toward an inside.

In a case where the hexagonal strontium ferrite powder includes the rare earth atom, a rare earth atom content (bulk content) is preferably in a range of 0.5 to 5.0 atom % with respect to 100 atom % of an iron atom. It is considered that a bulk content in the above range of the included rare earth atom and uneven distribution of the rare earth atoms in a surface layer portion of a particle constituting the hexagonal strontium ferrite powder contribute to suppression of a decrease in reproduction output during repeated reproduction. It is speculated that this is because the hexagonal strontium ferrite powder includes a rare earth atom with a bulk content in the above range, and rare earth atoms are unevenly distributed in a surface layer portion of a particle constituting the hexagonal strontium ferrite powder, whereby it is possible to increase an anisotropy constant Ku. The higher a value of an anisotropy constant Ku is, the more a phenomenon called thermal fluctuation can be suppressed (in other words, thermal stability can be improved). By suppressing the occurrence of thermal fluctuation, it is possible to suppress a decrease in reproduction output during repeated reproduction. It is speculated that uneven distribution of rare earth atoms in a particulate surface layer portion of the hexagonal strontium ferrite powder contributes to stabilization of spins of iron (Fe) sites in a crystal lattice of a surface layer portion, and thus, an anisotropy constant Ku may be increased.

It is speculated that the use of the hexagonal strontium ferrite powder having the rare earth atom surface layer portion uneven distribution property as the ferromagnetic powder of the magnetic layer contributes to the prevention of scraping of the surface of the magnetic layer due to the sliding on the magnetic head. That is, it is speculated that the hexagonal strontium ferrite powder having the rare earth atom surface layer portion uneven distribution property can also contribute to the improvement of running durability of the magnetic tape. It is speculated that this may be because uneven distribution of rare earth atoms on a surface of a particle constituting the hexagonal strontium ferrite powder contributes to an improvement of interaction between the particle surface and an organic substance (for example, a binding agent and/or an additive) contained in the magnetic layer, and, as a result, a strength of the magnetic layer is improved.

From the viewpoint of further suppressing a decrease in reproduction output during repeated reproduction and/or the viewpoint of further improving running durability, the rare earth atom content (bulk content) is more preferably in a range of 0.5 to 4.5 atom %, still more preferably in a range of 1.0 to 4.5 atom %, and still more preferably in a range of 1.5 to 4.5 atom %.

The bulk content is a content obtained by totally dissolving hexagonal strontium ferrite powder. In the present invention and the present specification, unless otherwise noted, the content of an atom means a bulk content obtained by totally dissolving the hexagonal strontium ferrite powder. The hexagonal strontium ferrite powder including a rare earth atom may include only one kind of rare earth atom as the rare earth atom, or may include two or more kinds of rare earth atoms. The bulk content in a case of including two or more kinds of rare earth atoms is obtained for the total of two or more kinds of rare earth atoms. This also applies to other components in the present invention and the present specification. That is, unless otherwise noted, a certain component may be used alone or in combination of two or more. A content amount or a content in a case where two or more components are used refers to that for the total of two or more components.

In a case where the hexagonal strontium ferrite powder includes a rare earth atom, the included rare earth atom need only be any one or more of rare earth atoms. As a rare earth atom that is preferable from the viewpoint of further suppressing a decrease in reproduction output during repeated reproduction, there are a neodymium atom, a samarium atom, an yttrium atom, and a dysprosium atom, here, the neodymium atom, the samarium atom, and the yttrium atom are more preferable, and a neodymium atom is still more preferable.

In the hexagonal strontium ferrite powder having a rare earth atom surface layer portion uneven distribution property, the rare earth atoms need only be unevenly distributed in the surface layer portion of a particle constituting the hexagonal strontium ferrite powder, and the degree of uneven distribution is not limited. For example, for the hexagonal strontium ferrite powder having a rare earth atom surface layer portion uneven distribution property, a ratio of a surface layer portion content of a rare earth atom obtained by partial dissolution under dissolution conditions which will be described below to a bulk content of a rare earth atom obtained by total dissolution under dissolution conditions which will be described below, that is, “surface layer portion content/bulk content” exceeds 1.0 and may be 1.5 or more. The fact that “surface layer portion content/bulk content” is larger than 1.0 means that in a particle constituting the hexagonal strontium ferrite powder, rare earth atoms are unevenly distributed in the surface layer portion (that is, more than an inside). Further, a ratio of a surface layer portion content of a rare earth atom obtained by partial dissolution under dissolution conditions which will be described below to a bulk content of a rare earth atom obtained by total dissolution under the dissolution conditions which will be described below, that is, “surface layer portion content/bulk content” may be, for example, 10.0 or less, 9.0 or less, 8.0 or less, 7.0 or less, 6.0 or less, 5.0 or less, or 4.0 or less. Note that, in the hexagonal strontium ferrite powder having a rare earth atom surface layer portion uneven distribution property, the rare earth atoms need only be unevenly distributed in the surface layer portion of a particle constituting the hexagonal strontium ferrite powder, and the “surface layer portion content/bulk content” is not limited to the exemplified upper limit or lower limit.

The partial dissolution and the total dissolution of the hexagonal strontium ferrite powder will be described below. For the hexagonal strontium ferrite powder present as a powder, the partially and totally dissolved sample powder is collected from the same lot of powder. Meanwhile, for the hexagonal strontium ferrite powder contained in the magnetic layer of the magnetic tape, a part of the hexagonal strontium ferrite powder extracted from the magnetic layer is subjected to partial dissolution, and the other part is subjected to total dissolution. The hexagonal strontium ferrite powder can be extracted from the magnetic layer by a method disclosed in a paragraph 0032 of JP2015-91747A, for example.

The partial dissolution means that dissolution is performed such that, at the end of dissolution, the residue of the hexagonal strontium ferrite powder can be visually confirmed in the solution. For example, by partial dissolution, it is possible to dissolve a region of 10 to 20 mass % of the particle constituting the hexagonal strontium ferrite powder with the total particle being 100 mass %. On the other hand, the total dissolution means that dissolution is performed such that, at the end of dissolution, the residue of the hexagonal strontium ferrite powder cannot be visually confirmed in the solution.

The partial dissolution and measurement of the surface layer portion content are performed by the following method, for example. Note that the following dissolution conditions such as the amount of sample powder are exemplified, and dissolution conditions for partial dissolution and total dissolution can be adopted in any manner.

A container (for example, a beaker) containing 12 mg of the sample powder and 10 mL of 1 mol/L hydrochloric acid is held on a hot plate at a set temperature of 70° C. for 1 hour. The obtained solution is filtered by a membrane filter of 0.1 μm. Elemental analysis of the filtrated solution thus obtained is performed by an inductively coupled plasma (ICP) analyzer. In this way, the surface layer portion content of a rare earth atom with respect to 100 atom % of an iron atom can be obtained. In a case where a plurality of kinds of rare earth atoms are detected by elemental analysis, the total content of all rare earth atoms is defined as the surface layer portion content. This also applies to the measurement of the bulk content.

Meanwhile, the total dissolution and measurement of the bulk content are performed by the following method, for example.

A container (for example, a beaker) containing 12 mg of the sample powder and 10 mL of 4 mol/L hydrochloric acid is held on a hot plate at a set temperature of 80° C. for 3 hours. Thereafter, the same procedure as the partial dissolution and the measurement of the surface layer portion content is carried out, and the bulk content with respect to 100 atom % of an iron atom can be obtained.

From the viewpoint of increasing the reproduction output in a case of reproducing data recorded on the magnetic tape, it is desirable that mass magnetization σs of the ferromagnetic powder included in the magnetic tape is high. In this regard, the hexagonal strontium ferrite powder including a rare earth atom but not having the rare earth atom surface layer portion uneven distribution property tends to have a larger decrease in σs than that of the hexagonal strontium ferrite powder including no rare earth atom. With respect to this, it is considered that the hexagonal strontium ferrite powder having a rare earth atom surface layer portion uneven distribution property is preferable in suppressing such a large decrease in σs. In one aspect, σs of the hexagonal strontium ferrite powder may be 45 A·m²/kg or more, and may be 47 A·m²/kg or more. On the other hand, from the viewpoint of noise reduction, σs is preferably 80 A·m²/kg or less and more preferably 60 A·m²/kg or less. σs can be measured using a well-known measuring device, such as a vibrating sample magnetometer, capable of measuring magnetic properties. In the present invention and the present specification, unless otherwise noted, the mass magnetization σs is a value measured at a magnetic field intensity of 15 kOe. 1 [kOe]=10⁶/4 π[A/m]

Regarding the content (bulk content) of a constituent atom of the hexagonal strontium ferrite powder, a strontium atom content may be, for example, in a range of 2.0 to 15.0 atom % with respect to 100 atom % of an iron atom. In one aspect, in the hexagonal strontium ferrite powder, the divalent metal atom included in this powder can be only a strontium atom. In another aspect, the hexagonal strontium ferrite powder may include one or more other divalent metal atoms in addition to the strontium atom. For example, a barium atom and/or a calcium atom can be included. In a case where the other divalent metal atoms other than the strontium atom are included, a content of the barium atom and a content of the calcium atom in the hexagonal strontium ferrite powder respectively can be, for example, in a range of 0.05 to 5.0 atom % with respect to 100 atom % of the iron atom.

As the hexagonal ferrite crystal structure, a magnetoplumbite type (also referred to as an “M type”), a W type, a Y type, and a Z type are known. The hexagonal strontium ferrite powder may have any crystal structure. The crystal structure can be confirmed by X-ray diffraction analysis. In the hexagonal strontium ferrite powder, a single crystal structure or two or more crystal structures may be detected by X-ray diffraction analysis. For example, according to one aspect, in the hexagonal strontium ferrite powder, only the M-type crystal structure may be detected by X-ray diffraction analysis. For example, M-type hexagonal ferrite is represented by a composition formula of AFe₁₂O₁₉. Here, A represents a divalent metal atom, and in a case where the hexagonal strontium ferrite powder is the M-type, A is only a strontium atom (Sr), or in a case where, as A, a plurality of divalent metal atoms are included, as described above, a strontium atom (Sr) accounts for the most on atom % basis. The divalent metal atom content of the hexagonal strontium ferrite powder is usually determined by the type of crystal structure of the hexagonal ferrite and is not particularly limited. The same applies to the iron atom content and the oxygen atom content. The hexagonal strontium ferrite powder may include at least an iron atom, a strontium atom, and an oxygen atom, and may further include a rare earth atom. Furthermore, the hexagonal strontium ferrite powder may or may not include atoms other than these atoms. As an example, the hexagonal strontium ferrite powder may include an aluminum atom (Al). A content of an aluminum atom may be, for example, 0.5 to 10.0 atom % with respect to 100 atom % of an iron atom. From the viewpoint of further suppressing a decrease in reproduction output during repeated reproduction, the hexagonal strontium ferrite powder includes an iron atom, a strontium atom, an oxygen atom, and a rare earth atom, and the content of atoms other than these atoms is preferably 10.0 atom % or less, more preferably in a range of 0 to 5.0 atom %, and may be 0 atom % with respect to 100 atom % of an iron atom. That is, in one aspect, the hexagonal strontium ferrite powder may not include atoms other than an iron atom, a strontium atom, an oxygen atom, and a rare earth atom. The content expressed in atom % is obtained by converting a content of each atom (unit: mass %) obtained by totally dissolving the hexagonal strontium ferrite powder into a value expressed in atom % using an atomic weight of each atom. Further, in the present invention and the present specification, the term “not include” for a certain atom means that a content measured by an ICP analyzer after total dissolution is 0 mass %. A detection limit of the ICP analyzer is usually 0.01 parts per million (ppm) or less on a mass basis. The term “not included” is used as a meaning including that an atom is included in an amount less than the detection limit of the ICP analyzer. In one aspect, the hexagonal strontium ferrite powder may not include a bismuth atom (Bi).

Metal Powder

Preferred specific examples of the ferromagnetic powder include a ferromagnetic metal powder. For details of the ferromagnetic metal powder, descriptions disclosed in paragraphs 0137 to 0141 of JP2011-216149A and paragraphs 0009 to 0023 of JP2005-251351A can be referred to, for example.

ϵ-Iron Oxide Powder

Preferred specific examples of the ferromagnetic powder include an ε-iron oxide powder. In the present invention and the present specification, the term “ε-iron oxide powder” refers to a ferromagnetic powder in which an ε-iron oxide type crystal structure is detected as a main phase by X-ray diffraction analysis. For example, in a case where the highest intensity diffraction peak is attributed to an ε-iron oxide type crystal structure in an X-ray diffraction spectrum obtained by X-ray diffraction analysis, it is determined that the ε-iron oxide type crystal structure is detected as the main phase. As a method of manufacturing the ε-iron oxide powder, a producing method from a goethite, a reverse micelle method, and the like are known. All of the manufacturing methods are well known. Regarding a method of manufacturing an ε-iron oxide powder in which a part of Fe is substituted with substitutional atoms such as Ga, Co, Ti, Al, or Rh, a description disclosed in J. Jpn. Soc. Powder Metallurgy Vol. 61 Supplement, No. S1, pp. 5280 to 5284, J. Mater. Chem. C, 2013, 1, pp. 5200 to 5206 can be referred to, for example. Note that the manufacturing method of the ε-iron oxide powder capable of being used as the ferromagnetic powder in the magnetic layer of the magnetic tape is not limited to the methods described here.

An activation volume of the ε-iron oxide powder is preferably in a range of 300 to 1500 nm³. The finely granulated ε-iron oxide powder having an activation volume in the above range is suitable for producing a magnetic tape exhibiting excellent electromagnetic conversion characteristics. The activation volume of the ε-iron oxide powder is preferably 300 nm³ or more, and may be, for example, 500 nm³ or more. In addition, from the viewpoint of further improving the electromagnetic conversion characteristics, the activation volume of the ε-iron oxide powder is more preferably 1400 nm³ or less, still more preferably 1300 nm³ or less, still more preferably 1200 nm³ or less, and still more preferably 1100 nm³ or less.

The anisotropy constant Ku can be used as an index for reducing thermal fluctuation, in other words, for improving the thermal stability. The ε-iron oxide powder preferably has Ku of 3.0×10⁴ J/m³ or more, and more preferably has Ku of 8.0×10⁴ J/m³ or more. Ku of the ϵ-iron oxide powder may be, for example, 3.0×10⁵ J/m³ or less. Note that since higher Ku means higher thermal stability, which is preferable, a value thereof is not limited to the values exemplified above.

From the viewpoint of increasing the reproduction output in a case of reproducing data recorded on the magnetic tape, it is desirable that mass magnetization σs of the ferromagnetic powder included in the magnetic tape is high. In this regard, in one aspect, σs of the ε-iron oxide powder may be 8 A·m²/kg or more, and may be 12 A·m²/kg or more. On the other hand, from the viewpoint of noise reduction, σs of the ε-iron oxide powder is preferably 40 A·m²/kg or less and more preferably 35 A·m²/kg or less.

In the present invention and the present specification, unless otherwise noted, an average particle size of various powders such as ferromagnetic powders is a value measured by the following method using a transmission electron microscope.

The powder is imaged at an imaging magnification of 100000 using a transmission electron microscope, and the image is printed on printing paper such that the total magnification is 500000 to obtain an image of particles constituting the powder. A target particle is selected from the obtained image of particles, an outline of the particle is traced by a digitizer, and a size of the particle (primary particle) is measured. The primary particles are independent particles without aggregation.

The measurement described above is performed regarding 500 particles randomly extracted. An arithmetic average of the particle sizes of 500 particles thus obtained is an average particle size of the powder. As the transmission electron microscope, a transmission electron microscope H-9000 manufactured by Hitachi, Ltd. can be used, for example. In addition, the measurement of the particle size can be performed by well-known image analysis software, for example, image analysis software KS-400 manufactured by Carl Zeiss. An average particle size shown in Examples which will be described below is a value measured by using a transmission electron microscope H-9000 manufactured by Hitachi, Ltd. as the transmission electron microscope, and image analysis software KS-400 manufactured by Carl Zeiss as the image analysis software, unless otherwise noted. In the present invention and the present specification, the powder means aggregation of a plurality of particles. For example, ferromagnetic powder means aggregation of a plurality of ferromagnetic particles. Further, the aggregation of the plurality of particles not only includes an aspect in which particles constituting the aggregate directly come into contact with each other, but also includes an aspect in which a binding agent or an additive which will be described below is interposed between the particles. The term “particle” is used to describe a powder in some cases.

As a method of collecting sample powder from the magnetic tape in order to measure the particle size, a method disclosed in a paragraph 0015 of JP2011-048878A can be adopted, for example.

In the present invention and the present specification, unless otherwise noted, (1) in a case where the shape of the particle observed in the particle photograph described above is a needle shape, a fusiform shape, or a columnar shape (here, a height is greater than a maximum long diameter of a bottom surface), the size (particle size) of the particles configuring the powder is shown as a length of a long axis configuring the particle, that is, a long axis length, (2) in a case where the shape of the particle is a plate shape or a columnar shape (here, a thickness or a height is smaller than a maximum long diameter of a plate surface or a bottom surface), the particle size is shown as a maximum long diameter of the plate surface or the bottom surface, and (3) in a case where the shape of the particle is a sphere shape, a polyhedron shape, or an amorphous shape, and the long axis configuring the particles cannot be specified from the shape, the particle size is shown as an equivalent circle diameter. The equivalent circle diameter refers to a value obtained by a circle projection method.

In addition, regarding an average acicular ratio of the powder, a length of a short axis, that is, a short axis length of the particles is measured in the measurement described above, a value of (long axis length/short axis length) of each particle is obtained, and an arithmetic average of the values obtained regarding 500 particles is calculated. Here, unless otherwise noted, in a case of (1), the short axis length as the definition of the particle size is a length of a short axis configuring the particle, in a case of (2), the short axis length is a thickness or a height, and in a case of (3), the long axis and the short axis are not distinguished, thus, the value of (long axis length/short axis length) is assumed as 1, for convenience.

In addition, unless otherwise noted, in a case where the shape of the particle is specified, for example, in a case of definition of the particle size (1), the average particle size is an average long axis length, and in a case of the definition (2), the average particle size is an average plate diameter. In a case of the definition (3), the average particle size is an average diameter (also referred to as an average particle diameter).

The content (filling percentage) of the ferromagnetic powder of the magnetic layer is preferably 50 to 90 mass % and more preferably 60 to 90 mass %. A high filling percentage of the ferromagnetic powder in the magnetic layer is preferable from the viewpoint of improvement of the recording density.

(Binding Agent)

The magnetic tape can be a coating type magnetic tape, and include a binding agent in the magnetic layer. The binding agent is one or more resins. As the binding agent, various resins usually used as a binding agent of a coating type magnetic recording medium can be used. For example, as the binding agent, a resin selected from a polyurethane resin, a polyester resin, a polyamide resin, a vinyl chloride resin, an acrylic resin obtained by copolymerizing styrene, acrylonitrile, or methyl methacrylate, a cellulose resin such as nitrocellulose, an epoxy resin, a phenoxy resin, and a polyvinylalkylal resin such as polyvinyl acetal or polyvinyl butyral can be used alone or a plurality of resins can be mixed with each other to be used. Among these, a polyurethane resin, an acrylic resin, a cellulose resin, and a vinyl chloride resin are preferable. These resins may be homopolymers or copolymers. These resins can be used as the binding agent even in a non-magnetic layer and/or a back coating layer which will be described below.

For the binding agent described above, descriptions disclosed in paragraphs 0028 to 0031 of JP2010-24113A can be referred to. An average molecular weight of the resin used as the binding agent can be, for example, 10,000 to 200,000 as a weight-average molecular weight. The weight-average molecular weight of the present invention and the present specification is a value obtained by performing polystyrene conversion of a value measured by gel permeation chromatography (GPC) under the following measurement conditions. The weight-average molecular weight of the binding agent shown in Examples described below is a value obtained by performing polystyrene conversion of a value measured under the following measurement conditions. The binding agent may be used in an amount of, for example, 1.0 to 30.0 parts by mass with respect to 100.0 parts by mass of the ferromagnetic powder.

GPC device: HLC-8120 (manufactured by Tosoh Corporation)

Column: TSK gel Multipore HXL-M (manufactured by Tosoh Corporation, 7.8 mm inner diameter (ID)×30.0 cm)

Eluent: Tetrahydrofuran (THF)

(Curing Agent)

A curing agent can also be used together with the resin which can be used as the binding agent. As the curing agent, in one aspect, a thermosetting compound which is a compound in which curing reaction (crosslinking reaction) proceeds due to heating can be used, and in another aspect, a photocurable compound in which a curing reaction (crosslinking reaction) proceeds due to light irradiation can be used. At least a part of the curing agent is contained in the magnetic layer in a state of being reacted (crosslinked) with other components such as the binding agent, by proceeding of the curing reaction in the magnetic layer forming step. The same applies to the layer formed using this composition in a case where the composition used to form the other layer includes a curing agent. The preferred curing agent is a thermosetting compound, polyisocyanate is suitable. For details of the polyisocyanate, descriptions disclosed in paragraphs 0124 and 0125 of JP2011-216149A can be referred to. The curing agent can be used in the magnetic layer forming composition in an amount of, for example, 0 to 80.0 parts by mass, and preferably 50.0 to 80.0 parts by mass from the viewpoint of improving a strength of the magnetic layer, with respect to 100.0 parts by mass of the binding agent.

(Additive)

The magnetic layer may include one or more kinds of additives, as necessary. As the additives, the curing agent described above is used as an example. In addition, examples of the additive which can be contained in the magnetic layer include a non-magnetic powder (for example, an inorganic powder or carbon black), a lubricant, a dispersing agent, a dispersing assistant, an antibacterial agent, an antistatic agent, an antioxidant, and the like. For example, for the lubricant, descriptions disclosed in paragraphs 0030 to 0033, 0035, and 0036 of JP2016-126817A can be referred to. The non-magnetic layer described below may include a lubricant. For the lubricant which may be included in the non-magnetic layer, descriptions disclosed in paragraphs 0030, 0031, and 0034 to 0036 of JP2016-126817A can be referred to. For the dispersing agent, descriptions disclosed in paragraphs 0061 and 0071 of JP2012-133837A can be referred to. The dispersing agent may be added to a non-magnetic layer forming composition. For the dispersing agent that can be added to the non-magnetic layer forming composition, a description disclosed in a paragraph 0061 of JP2012-133837A can be referred to. As the non-magnetic powder that can be included in the magnetic layer, a non-magnetic powder which can function as an abrasive, or a non-magnetic powder which can function as a protrusion forming agent which forms protrusions appropriately protruded from the magnetic layer surface (for example, non-magnetic colloidal particles) is used. An average particle size of colloidal silica (silica colloidal particles) shown in Examples described below is a value obtained by a method disclosed as a measurement method of an average particle diameter in a paragraph 0015 of JP2011-048878A. As the additive, a commercially available product can be suitably selected or manufactured by a well-known method according to the desired properties, and any amount thereof can be used. As an example of the additive which can be used for improving dispersibility of the abrasive in the magnetic layer including the abrasive, a dispersing agent disclosed in paragraphs 0012 to 0022 of JP2013-131285A can be used.

The magnetic layer described above can be provided on a surface of the non-magnetic support directly or indirectly through the non-magnetic layer.

<Non-Magnetic Layer>

Next, the non-magnetic layer will be described. The above magnetic tape may have a magnetic layer directly on the surface of the non-magnetic support, or may have a magnetic layer on the surface of the non-magnetic support through a non-magnetic layer including a non-magnetic powder. The non-magnetic powder used for the non-magnetic layer may be an inorganic substance powder or an organic substance powder. In addition, carbon black and the like can be used. Examples of the inorganic substance powder include powders of metal, metal oxide, metal carbonate, metal sulfate, metal nitride, metal carbide, and metal sulfide. These non-magnetic powders can be purchased as a commercially available product or can be manufactured by a well-known method. For details thereof, descriptions disclosed in paragraphs 0146 to 0150 of JP2011-216149A can be referred to. For carbon black which can be used in the non-magnetic layer, descriptions disclosed in paragraphs 0040 and 0041 of JP2010-24113A can be referred to. The content (filling percentage) of the non-magnetic powder of the non-magnetic layer is preferably 50 to 90 mass % and more preferably 60 to 90 mass %.

The non-magnetic layer can include a binding agent, and can also include an additive. For other details of the binding agent or the additive of the non-magnetic layer, a well-known technology regarding the non-magnetic layer can be applied. In addition, in regards to the type and the content of the binding agent, and the type and the content of the additive, for example, a well-known technology regarding the magnetic layer can be applied.

The non-magnetic layer of the present invention and the present specification also includes a substantially non-magnetic layer containing a small amount of ferromagnetic powder as impurities or intentionally, together with the non-magnetic powder. Here, the substantially non-magnetic layer is a layer having a residual magnetic flux density equal to or smaller than 10 mT, a layer having a coercivity equal to or smaller than 7.96 kA/m (100 Oe), or a layer having a residual magnetic flux density equal to or smaller than 10 mT and a coercivity equal to or smaller than 7.96 kA/m (100 Oe). It is preferable that the non-magnetic layer does not have a residual magnetic flux density and a coercivity.

<Back Coating Layer>

The magnetic tape may or may not include a back coating layer including a non-magnetic powder on a surface side of the non-magnetic support opposite to a surface side on which the magnetic layer is provided. The back coating layer preferably contains any one or both of carbon black and an inorganic powder. The back coating layer can include a binding agent and can also include additives. In regards to the binding agent and the additive of the back coating layer, a well-known technology regarding the back coating layer can be applied, and a well-known technology regarding the formulation of components of the magnetic layer and/or the non-magnetic layer can be applied. For example, for the back coating layer, descriptions disclosed in paragraphs 0018 to 0020 of JP2006-331625A and column 4, line 65 to column 5, line 38 of U.S. Pat. No. 7,029,774B can be referred to.

<Various Thicknesses>

Regarding a thickness (total thickness) of the magnetic tape, it has been required to increase the recording capacity (increase the capacity) of the magnetic tape with the enormous increase in the amount of information in recent years. For example, as means for increasing the capacity, a thickness of the magnetic tape may be reduced (hereinafter, also referred to as “thinning”) to increase a length of the magnetic tape accommodated in the magnetic recording and reproducing device. From this point, the thickness (total thickness) of the magnetic tape is preferably 5.6 μm or less, more preferably 5.5 μm or less, still more preferably 5.4 μm or less, still more preferably 5.3 μm or less, and still more preferably 5.2 μm or less. In addition, from the viewpoint of ease of handling, the thickness of the magnetic tape is preferably 3.0 μm or more, and more preferably 3.5 μm or more.

The thickness (total thickness) of the magnetic tape can be measured by the following method.

Ten tape samples (for example, 5 to 10 cm in length) are cut out from any part of the magnetic tape, and these tape samples are stacked to measure the thickness. A value (thickness per tape sample) obtained by dividing the measured thickness by 1/10 is defined as the tape thickness. The thickness measurement can be performed using a well-known measuring instrument capable of measuring a thickness on the order of 0.1 μm.

A thickness of the non-magnetic support is preferably 3.0 to 5.0 μm.

A thickness of the magnetic layer can be optimized according to a saturation magnetization amount of a magnetic head used, a head gap length, a recording signal band, and the like, is generally 0.01 μm to 0.15 μm, and is preferably 0.02 μm to 0.12 μm and more preferably 0.03 μm to 0.1 μm, from a viewpoint of realization of high-density recording. The magnetic layer need only be at least a single layer, the magnetic layer may be separated into two or more layers having different magnetic properties, and a configuration of a well-known multilayered magnetic layer can be applied as the magnetic layer. The thickness of the magnetic layer in a case where the magnetic layer is separated into two or more layers is a total thickness of the layers.

A thickness of the non-magnetic layer is, for example, 0.1 to 1.5 μm, and preferably 0.1 to 1.0 μm.

A thickness of the back coating layer is preferably 0.9 μm or less, and more preferably 0.1 to 0.7 μm.

Various thicknesses such as the thickness of the magnetic layer and the like can be obtained by the following method.

A cross section of the magnetic tape in a thickness direction is exposed by an ion beam, and then observation on the exposed cross section is performed using a scanning electron microscope. Various thicknesses can be obtained as an arithmetic average of thicknesses obtained at two optional points in the cross section observation. Alternatively, the various thicknesses can be obtained as a designed thickness calculated according to manufacturing conditions.

<Manufacturing Step>

(Preparation of Each Layer Forming Composition)

A step of preparing a composition for forming the magnetic layer, the non-magnetic layer, or the back coating layer can usually include at least a kneading step, a dispersing step, and, as necessary, a mixing step provided before and after these steps. Each step may be divided into two or more stages. Components used for the preparation of each layer forming composition may be added at an initial stage or in a middle stage of each step. As a solvent, one or more kinds of various solvents usually used for manufacturing a coating type magnetic recording medium can be used. For the solvent, for example, a description disclosed in a paragraph 0153 of JP2011-216149A can be referred to. In addition, each component may be separately added in two or more steps. For example, a binding agent may be added separately in a kneading step, a dispersing step, and a mixing step for adjusting a viscosity after dispersion. In order to manufacture the above magnetic tape, a well-known manufacturing technology can be used in various steps. In the kneading step, an open kneader, a continuous kneader, a pressure kneader, or a kneader having a strong kneading force such as an extruder is preferably used. For details of the kneading treatment, descriptions disclosed in JP1989-106338A (JP-H01-106338A) and JP1989-79274A (JP-H01-79274A) can be referred to. As a disperser, a well-known disperser can be used. In any stage of preparing each layer forming composition, filtering may be performed by a well-known method. The filtering can be performed by using a filter, for example. As the filter used in the filtering, a filter having a pore diameter of 0.01 to 3 μm (for example, filter made of glass fiber or filter made of polypropylene) can be used, for example.

(Coating Step)

The magnetic layer can be formed by directly applying the magnetic layer forming composition onto the non-magnetic support surface or performing multilayer coating of the magnetic layer forming composition with the non-magnetic layer forming composition in order or at the same time. The back coating layer can be formed by applying a back coating layer forming composition onto a surface of the non-magnetic support opposite to a surface having the non-magnetic layer and/or the magnetic layer (or to be provided with the non-magnetic layer and/or the magnetic layer). For details of the coating for forming each layer, a description disclosed in a paragraph 0066 of JP2010-231843A can be referred to.

(Other Steps)

Well-known technologies can be applied to other various steps for manufacturing the magnetic tape. For the various processes, for example, descriptions disclosed in paragraphs 0067 to 0070 of JP2010-231843A can be referred to. For example, a coating layer of the magnetic layer forming composition can be subjected to an orientation treatment in an orientation zone while the coating layer is in a wet state. For the alignment treatment, various well-known technologies including a description disclosed in a paragraph 0052 of JP2010-24113A can be used. For example, a vertical alignment treatment can be performed by a well-known method such as a method using a polar opposing magnet. In the alignment zone, a drying speed of the coating layer can be controlled depending on a temperature of dry air and an air volume and/or a transportation speed in the alignment zone. In addition, the coating layer may be preliminarily dried before the transportation to the alignment zone.

Through various steps, a long magnetic tape original roll can be obtained. The obtained magnetic tape original roll is cut (slit) by a well-known cutter to have a width of the magnetic tape to be wound around a tape reel of the magnetic recording and reproducing device. The width is determined according to the standard and is usually ½ inches. ½ inches=12.65 mm.

A servo pattern is usually formed on the magnetic tape obtained by slitting. Details of the servo pattern will be described below.

(Heat Treatment)

In one aspect, the magnetic tape can be a magnetic tape manufactured through the following heat treatment.

As the heat treatment, the magnetic tape slit and cut to have a width determined according to the standard described above can be wound around a core member and can be subjected to the heat treatment in the wound state.

In one aspect, a magnetic recording and reproducing device in which the magnetic tape and the magnetic head are accommodated in the sealed space can be produced by performing the heat treatment in a state where the magnetic tape is wound around a core member for heat treatment (hereinafter, referred to as a “winding core for heat treatment”), winding the magnetic tape after the heat treatment around the tape reel of the magnetic recording and reproducing device, accommodating the tape reel in the sealed space together with the magnetic head.

The winding core for heat treatment can be formed of metal, a resin, or paper. The material of the winding core for heat treatment is preferably a material having high stiffness, from the viewpoint of suppressing the occurrence of winding failure such as spoking. From this point, the winding core for heat treatment is preferably formed of metal or a resin. In addition, as an index for stiffness, a bending elastic modulus of the material of the winding core for heat treatment is preferably 0.2 GPa (Gigapascal) or more, and more preferably 0.3 GPa or more. Meanwhile, since the material having high stiffness is generally expensive, the use of the winding core for heat treatment of the material having stiffness exceeding the stiffness capable of suppressing the occurrence of the winding failure leads to an increase in cost. Considering the above point, the bending elastic modulus of the material of the winding core for heat treatment is preferably 250 GPa or less. The bending elastic modulus is a value measured in accordance with international organization for standardization (ISO) 178, and the bending elastic modulus of various materials is well-known. In addition, the winding core for heat treatment can be a solid or hollow core member. In a case of the hollow core member, a thickness thereof is preferably 2 mm or more from the viewpoint of maintaining stiffness. In addition, the winding core for heat treatment may include or may not include a flange.

It is preferable to prepare a magnetic tape having a length equal to or more than a length to be finally accommodated in the magnetic recording and reproducing device (hereinafter, referred to as a “final product length”) as the magnetic tape wound around the winding core for heat treatment, and to perform the heat treatment by placing the magnetic tape in a heat treatment environment while being wound around the winding core for heat treatment. The length of the magnetic tape wound around the winding core for heat treatment is equal to or more than the final product length, and is preferably the “final product length+α”, from the viewpoint of ease of winding around the winding core for heat treatment. This a is preferably 5 m or more, from the viewpoint of ease of the winding. The tension during winding around the winding core for heat treatment is preferably 0.1 N (Newton) or more. In addition, from the viewpoint of suppressing the occurrence of excessive deformation, the tension during winding around the winding core for heat treatment is preferably 1.5 N or less, and more preferably 1.0 N or less. An outer diameter of the winding core for heat treatment is preferably 20 mm or more and more preferably 40 mm or more, from the viewpoint of ease of the winding and suppression of coiling (curling in longitudinal direction). In addition, the outer diameter of the winding core for heat treatment is preferably 100 mm or less, and more preferably 90 mm or less. A width of the winding core for heat treatment need only be equal to or more than the width of the magnetic tape wound around this winding core. In addition, in a case where the magnetic tape is removed from the winding core for heat treatment after the heat treatment, it is preferable to remove the magnetic tape from the winding core for heat treatment after the magnetic tape and the winding core for heat treatment are sufficiently cooled, in order to suppress occurrence of unintended deformation of the tape during the removal operation. It is preferable that the removed magnetic tape is once wound around another winding core (referred to as a “temporary winding core”), and then the magnetic tape is wound around the tape reel (for example, an outer diameter is about 40 to 50 mm.) of the magnetic recording and reproducing device from the temporary winding core. As a result, the magnetic tape can be wound around the tape reel of the magnetic recording and reproducing device while maintaining a relationship between the inner side and the outer side with respect to the winding core for heat treatment of the magnetic tape during the heat treatment. Regarding the details of the temporary winding core and the tension in a case of winding the magnetic tape around the winding core, the description described above regarding the winding core for heat treatment can be referred to. In an aspect in which the heat treatment is applied to the magnetic tape having a length of the “final product length+α”, the length corresponding to “+α” need only be cut off in any stage. For example, in one aspect, the magnetic tape for the final product length need only be wound around the tape reel of the magnetic recording and reproducing device from the temporary winding core, and the remaining length corresponding to “+α” need only be cut off. From the viewpoint of reducing a portion to be cut off and discarded, the α is preferably 20 m or less.

A specific aspect of the heat treatment performed in a state where the magnetic tape is wound around the core member as described above will be described below.

An atmosphere temperature at which the heat treatment is performed (hereinafter, referred to as a “heat treatment temperature”) is preferably 40° C. or higher, and more preferably 50° C. or higher. On the other hand, from the viewpoint of suppressing excessive deformation, the heat treatment temperature is preferably 75° C. or lower, more preferably 70° C. or lower, and still more preferably 65° C. or lower.

A weight-basis absolute humidity of an atmosphere in which the heat treatment is performed is preferably 0.1 g/kg Dry air or more, and more preferably 1 g/kg Dry air or more. An atmosphere having a weight-basis absolute humidity in the above range is preferable because it can be prepared without using a special device for reducing moisture. On the other hand, the weight-basis absolute humidity is preferably 70 g/kg Dry air or less, and more preferably 66 g/kg Dry air or less, from the viewpoint of suppressing occurrence of dew condensation and deterioration of workability. A heat treatment time is preferably 0.3 hours or longer, and more preferably 0.5 hours or longer. In addition, the heat treatment time is preferably 48 hours or less, from the viewpoint of production efficiency.

(Formation of Servo Pattern)

The term “formation of servo pattern” can also be referred to as “recording of servo signal”. The formation of the servo pattern will be described below.

The servo pattern is usually formed along the longitudinal direction of the magnetic tape. Examples of control (servo control) systems using a servo signal include a timing-based servo (TBS), an amplitude servo, and a frequency servo.

As shown in European Computer Manufacturers Association (ECMA)-319 (June 2001), a timing-based servo system is adopted in a magnetic tape based on a linear tape-open (LTO) standard (generally referred to as an “LTO tape”). In this timing-based servo system, the servo pattern is formed by continuously disposing a plurality of pairs of non-parallel magnetic stripes (also referred to as “servo stripes”) in the longitudinal direction of the magnetic tape. In the present invention and the present specification, the term “timing-based servo pattern” refers to a servo pattern that enables head tracking in a timing-based servo system. As described above, the reason why the servo pattern is formed of a pair of non-parallel magnetic stripes is to indicate, to a servo signal reading element passing over the servo pattern, a passing position thereof. Specifically, the pair of magnetic stripes is formed such that an interval thereof continuously changes along a width direction of the magnetic tape, and the servo signal reading element reads the interval to thereby sense a relative position between the servo pattern and the servo signal reading element. Information on this relative position enables tracking on a data track. Accordingly, a plurality of servo tracks are usually set on the servo pattern along the width direction of the magnetic tape.

A servo band is formed of a servo pattern continuous in the longitudinal direction of the magnetic tape. A plurality of the servo bands are usually provided on the magnetic tape. For example, in an LTO tape, the number of the servo bands is five. Regions interposed between two adjacent servo bands are data bands. The data band is formed of a plurality of data tracks and each data track corresponds to each servo track.

Further, in one aspect, as shown in JP2004-318983A, information indicating a servo band number (referred to as “servo band identification (ID)” or “unique data band identification method (UDIM) information”) is embedded in each servo band. This servo band ID is recorded by shifting a specific one of the plurality of pairs of the servo stripes in the servo band so that positions thereof are relatively displaced in the longitudinal direction of the magnetic tape. Specifically, a way of shifting the specific one of the plurality of pairs of servo stripes is changed for each servo band. Accordingly, the recorded servo band ID is unique for each servo band, and thus, the servo band can be uniquely specified only by reading one servo band with a servo signal reading element.

As a method for uniquely specifying the servo band, there is a method using a staggered method as shown in ECMA-319 (June 2001). In this staggered method, a group of pairs of non-parallel magnetic stripes (servo stripes) disposed continuously in plural in a longitudinal direction of the magnetic tape is recorded so as to be shifted in a longitudinal direction of the magnetic tape for each servo band. Since this combination of shifting methods between adjacent servo bands is unique throughout the magnetic tape, it is possible to uniquely specify a servo band in a case of reading a servo pattern with two servo signal reading elements.

As shown in ECMA-319 (June 2001), information indicating a position of the magnetic tape in the longitudinal direction (also referred to as “longitudinal position (LPOS) information”) is usually embedded in each servo band. This LPOS information is also recorded by shifting the positions of the pair of servo stripes in the longitudinal direction of the magnetic tape, as the UDIM information. Note that, unlike the UDIM information, in this LPOS information, the same signal is recorded in each servo band.

It is also possible to embed, in the servo band, the other information different from the above UDIM information and LPOS information. In this case, the embedded information may be different for each servo band as the UDIM information or may be common to all servo bands as the LPOS information.

As a method of embedding the information in the servo band, a method other than the method described above can be used. For example, a predetermined code may be recorded by thinning out a predetermined pair from the group of pairs of servo stripes.

A head for forming a servo pattern is called a servo write head. The servo write head usually has a pair of gaps corresponding to the pair of magnetic stripes as many as the number of servo bands. Usually, a core and a coil are connected to each pair of gaps, and by supplying a current pulse to the coil, a magnetic field generated in the core can cause generation of a leakage magnetic field in the pair of gaps. In a case of forming the servo pattern, by inputting a current pulse while running the magnetic tape on the servo write head, the magnetic pattern corresponding to the pair of gaps is transferred to the magnetic tape to form the servo pattern. A width of each gap can be appropriately set according to a density of the servo pattern to be formed. The width of each gap can be set to, for example, 1 μm or less, 1 to 10 μm, 10 μm or more, and the like.

Before the servo pattern is formed on the magnetic tape, the magnetic tape is usually subjected to a demagnetization (erasing) treatment. This erasing treatment can be performed by applying a uniform magnetic field to the magnetic tape using a direct current magnet or an alternating current magnet. The erasing treatment includes direct current (DC) erasing and alternating current (AC) erasing. The AC erasing is performed by gradually decreasing an intensity of the magnetic field while reversing a direction of the magnetic field applied to the magnetic tape. Meanwhile, the DC erasing is performed by applying a unidirectional magnetic field to the magnetic tape. The DC erasing further includes two methods. A first method is horizontal DC erasing of applying a unidirectional magnetic field along a longitudinal direction of the magnetic tape. A second method is vertical DC erasing of applying a unidirectional magnetic field along a thickness direction of the magnetic tape. The erasing treatment may be performed on the entire magnetic tape or may be performed for each servo band of the magnetic tape.

A direction of the magnetic field of the servo pattern to be formed is determined according to a direction of the erasing. For example, in a case where the horizontal DC erasing is performed to the magnetic tape, the servo pattern is formed so that the direction of the magnetic field is opposite to the direction of the erasing. Therefore, an output of a servo signal obtained by reading the servo pattern can be increased. As disclosed in JP2012-53940A, in a case where a magnetic pattern is transferred to, using the gap, a magnetic tape that has been subjected to vertical DC erasing, a servo signal obtained by reading the formed servo pattern has a monopolar pulse shape. Meanwhile, in a case where a magnetic pattern is transferred to, using the gap, a magnetic tape that has been subjected to horizontal DC erasing, a servo signal obtained by reading the formed servo pattern has a bipolar pulse shape.

<Magnetic Head>

The magnetic head accommodated in the sealed space of the magnetic recording and reproducing device can be a recording head capable of performing the recording of data on the magnetic tape, or can be a reproducing head capable of performing the reproducing of data recorded on the magnetic tape. In addition, in one aspect, the magnetic recording and reproducing device can include both a recording head and a reproducing head as separate magnetic heads. In another aspect, the magnetic head included in the magnetic tape device may have a configuration in which both a recording element and a reproducing element are provided in one magnetic head. As the reproducing head, a magnetic head (MR head) including a magnetoresistive (MR) element capable of sensitively reading information recorded on the magnetic tape as a reproducing element is preferable. As the MR head, various well-known MR heads (for example, a giant magnetoresistive (GMR) head and a tunnel magnetoresistive (TMR) head) can be used. In addition, the magnetic head which performs the recording of data and/or the reproducing of data may include a servo signal reading element. Alternatively, as a head other than the magnetic head which performs the recording of data and/or the reproducing of data, a magnetic head (servo head) comprising a servo signal reading element may be included in the magnetic tape device. For example, a magnetic head that records data and/or reproduces recorded data (hereinafter also referred to as “recording and reproducing head”) can include two servo signal reading elements, and the two servo signal reading elements can simultaneously read two adjacent servo bands with the data band interposed therebetween. One or a plurality of elements for data can be disposed between the two servo signal reading elements. An element for recording data (recording element) and an element for reproducing data (reproducing element) are collectively referred to as an “element for data”.

In a case of recording data and/or reproducing recorded data, first, tracking using the servo signal can be performed. That is, by causing the servo signal reading element to follow a predetermined servo track, the element for data can be controlled to pass on the target data track. Displacement of the data track is performed by changing a servo track read by the servo signal reading element in a tape width direction.

The recording and reproducing head can also perform recording and/or reproduction with respect to other data bands. In this case, the servo signal reading element need only be displaced to a predetermined servo band using the above described UDIM information to start tracking for the servo band.

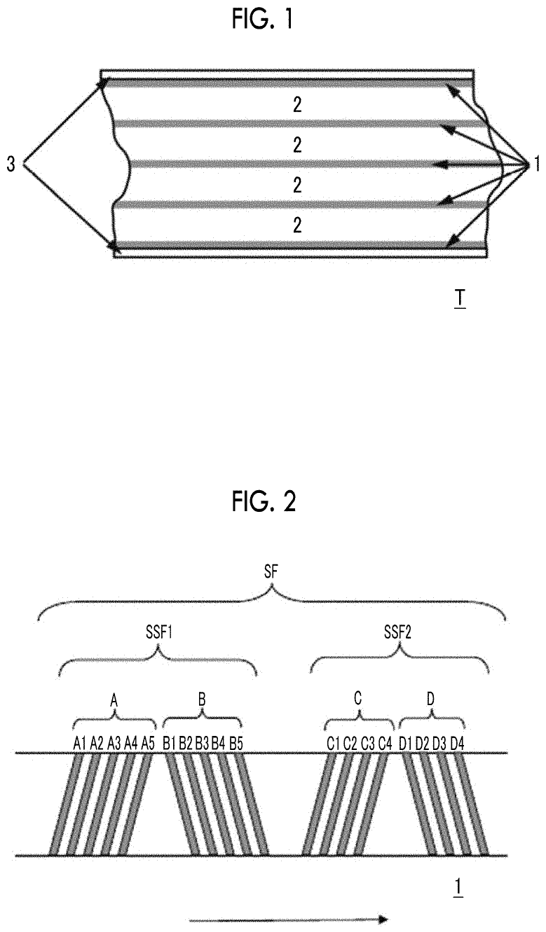

FIG. 1 shows an arrangement example of the data band and the servo band. In FIG. 1, in the magnetic layer of a magnetic tape T, a plurality of servo bands 1 are arranged so as to be interposed between guide bands 3. A plurality of regions 2 interposed between two servo bands are data bands. The servo pattern is a magnetization region, and is formed by magnetizing a specific region of the magnetic layer by the servo write head. A region magnetized by the servo write head (a position where the servo pattern is formed) is determined by the standard. For example, in an LTO Ultrium format tape which is based on a local standard, a plurality of servo patterns inclined with respect to a tape width direction as shown in FIG. 2 are formed on a servo band, in a case of manufacturing a magnetic tape. Specifically, in FIG. 2, a servo frame SF on the servo band 1 is composed of a servo sub-frame 1 (SSF1) and a servo sub-frame 2 (SSF2). The servo sub-frame 1 is composed of an A burst (in FIG. 2, reference numeral A) and a B burst (in FIG. 2, reference numeral B). The A burst is composed of servo patterns A1 to A5 and the B burst is composed of servo patterns B1 to B5. Meanwhile, the servo sub-frame 2 is composed of a C burst (in FIG. 2, reference numeral C) and a D burst (in FIG. 2, reference numeral D). The C burst is composed of servo patterns C1 to C4 and the D burst is composed of servo patterns D1 to D4. Such 18 servo patterns are arranged in the sub-frames in an array of 5, 5, 4, 4, as the sets of 5 servo patterns and 4 servo patterns, and are used for identifying the servo frames. FIG. 2 shows one servo frame for description. Note that, in practice, a plurality of the servo frames are arranged in the running direction in each servo band in the magnetic layer of the magnetic tape on which the head tracking of the timing-based servo system is performed. In FIG. 2, an arrow shows a running direction. For example, an LTO Ultrium format tape usually has 5000 or more servo frames per 1 m of tape length in each servo band of the magnetic layer.

<Configuration Example of Magnetic Recording And Reproducing Device>

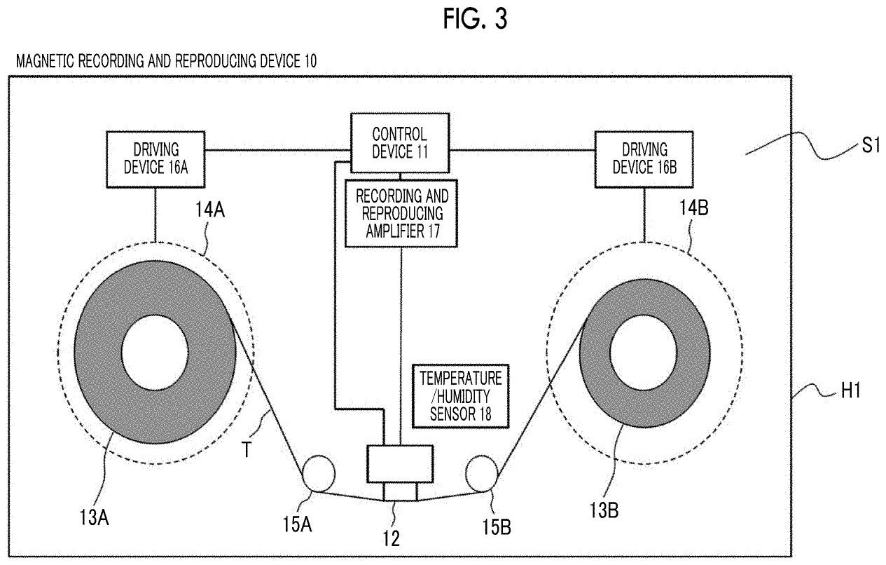

FIG. 3 shows a configuration example of the magnetic recording and reproducing device. In a magnetic recording and reproducing device 10 shown in FIG. 3, an internal space S1 in a housing H1 that covers the entire magnetic recording and reproducing device, that is, the entire internal space of the magnetic recording and reproducing device 10 is a sealed space. The entire internal space of the housing H1 can be made a sealed space by sealing the housing H1 by well-known sealing means (adhesive fastening, bolting, silicon packing, welding, or the like) after a magnetic tape, a magnetic head, or the like are disposed inside.

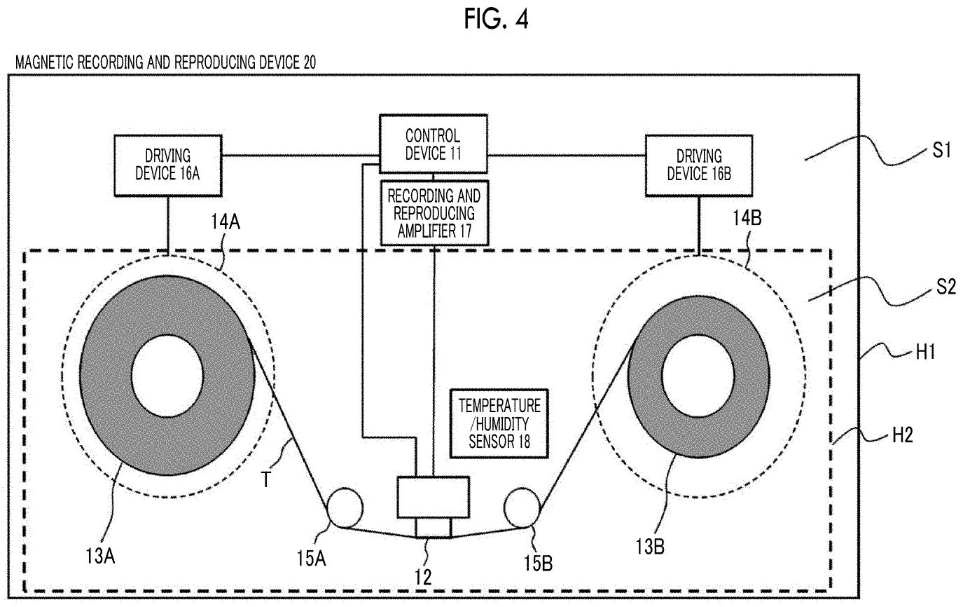

FIG. 4 shows another configuration example of the magnetic recording and reproducing device. In a magnetic recording and reproducing device 20 shown in FIG. 4, a housing H2 is disposed in an internal space S1 of a housing H1 that covers the entire magnetic recording and reproducing device. The internal space S2 of the housing H2 is a sealed space including a magnetic tape and a magnetic head. That is, the space S2 that is a part of the internal space S1 of the magnetic recording and reproducing device 20 is a sealed space. In this case, the entire internal space in the housing H1 may be a sealed space or may not be a sealed space. That is, in a case where a part of the internal space in the magnetic recording and reproducing device is a sealed space, the entire internal space of the magnetic recording and reproducing device may be a sealed space or may not be a sealed space. Regarding the sealing means for sealing the housing H2 and making the internal space S2 of the housing H2 a sealed space, the above-described description can be referred to.

In an aspect in which the sealed space including a magnetic tape and a magnetic head is a part of the internal space of the magnetic recording and reproducing device, such a sealed space preferably includes at least a tape reel, a guide roller, and a humidity sensor, and may further include one or more of a recording and reproducing amplifier, a driving device, and a control device.

In both an aspect in which the entire internal space of the magnetic recording and reproducing device is a sealed space or an aspect in which a part of the internal space is a sealed space, an internal volume of the sealed space need only be a volume for accommodating a magnetic tape, a magnetic tape head, and various components to be accommodated in the sealed space. In one aspect, the internal volume of the sealed space is preferably in a range of 1 L (liter) to 3 L.

Hereinafter, various components of the magnetic recording and reproducing device shown in FIGS. 3 and 4 will be further described.

In the magnetic recording and reproducing device shown in FIGS. 3 and 4, recording of data on the magnetic tape T and reproduction of the data recorded on the magnetic tape T are performed by controlling a recording and reproducing head unit 12 according to an instruction from a control device 11.

The magnetic recording and reproducing devices 10 and 20 have a configuration capable of detecting and adjusting the tension applied in the longitudinal direction of the magnetic tape from spindle motors 14A and 14B for controlling rotation of two tape reels 13A and 13B and driving devices 16A and 16B of the spindle motors 14A and 14B.

In the magnetic recording and reproducing devices 10 and 20, the magnetic tape T passes over guide rollers 15A and 15B in a direction in which the magnetic layer surface of the magnetic tape T is in contact with the recording and reproducing head surface of the recording and reproducing head unit 12, and runs between the tape reel 13A and the tape reel 13B.

The rotation and torque of the spindle motors 14A and 14B are controlled by a signal from the control device 11, and the magnetic tape T is run at any speed and tension. A servo pattern previously formed on the magnetic tape can be used to control the tape speed. In order to detect the tension, a tension detecting mechanism may be provided between the two tape reels 13A and 13B. The tension may be adjusted by using the guide rollers 15A and 15B in addition to the control performed by the spindle motors 14A and 14B.

The control device 11 includes, for example, a control unit, a storage unit, a communication unit, and the like.

The recording and reproducing head unit 12 includes, for example, a recording and reproducing head, a servo tracking actuator that adjusts a position of the recording and reproducing head in the track width direction, a recording and reproducing amplifier 17, a connector cable for connection with the control device 11, and the like. The recording and reproducing head includes, for example, a recording element for recording data on the magnetic tape, a reproducing element for reproducing data on the magnetic tape, and a servo signal reading element for reading a servo signal recorded on the magnetic tape. For example, one or more recording elements, reproducing elements, and servo signal reading elements are mounted in one magnetic head. Alternatively, each element may be separately provided in a plurality of magnetic heads according to the running direction of the magnetic tape.

The recording and reproducing head unit 12 is configured to be capable of recording data on the magnetic tape T in response to an instruction from the control device 11. In addition, the recording and reproducing head unit 12 is configured to be capable of reproducing the data recorded on the magnetic tape T is configured to be able to be reproduced in response to an instruction from the control device 11. In a case of performing recording and/or reproduction, in one aspect, the magnetic layer surface of the magnetic tape and the magnetic head come into contact with each other to be slid on each other, and data is recorded on the magnetic tape and/or data recorded on the magnetic tape is reproduced by the magnetic head. The magnetic recording and reproducing device according to such an aspect is generally called a sliding type drive or a contact sliding type drive. In the present invention and the present specification, the term “the magnetic layer surface of the magnetic tape” has the same meaning as a surface of the magnetic tape on a magnetic layer side. In another aspect, the magnetic head records data on the magnetic tape and/or reproduces data recorded on the magnetic tape in a non-contact state with the magnetic layer surface, except in random contact. The magnetic recording and reproducing device according to such an aspect is generally called a levitation type drive.

The control device 11 has a mechanism for obtaining the running position of the magnetic tape from the servo signal read from the servo band in a case where the magnetic tape T is run, and controlling the servo tracking actuator such that the recording element and/or the reproducing element is located at a target running position (track position). The track position is controlled by feedback control, for example. The control device 11 has a mechanism for obtaining a servo band interval from servo signals read from two adjacent servo bands in a case where the magnetic tape T is run. In addition, the control device 11 has a mechanism for adjusting and changing the tension applied in the longitudinal direction of the magnetic tape by controlling the torque of the spindle motor 14A and the spindle motor 14B and/or the guide rollers 15A and 15B such that the servo band interval becomes a target value. The tension is adjusted by feedback control, for example. In addition, the control device 11 can store the obtained information on the servo band interval in the storage unit inside the control device 11, an external connection device, or the like.

In the magnetic recording and reproducing devices 10 and 20, tension can be applied in the longitudinal direction of the magnetic tape at one or more timings of recording, reproduction, and winding around the tape reel during a period between the recording and/or reproduction and storage. The tension applied to the magnetic tape in the longitudinal direction is a constant value in one aspect and changes in another aspect. Regarding the tension in the present invention and the present specification, a value of the tension applied in the longitudinal direction of the magnetic tape is a value input to the control device to control a mechanism for adjusting the tension as the tension to be applied in the longitudinal direction of the magnetic tape. In addition, the tension actually applied in the longitudinal direction of the magnetic tape can be detected, for example, by providing a tension detecting mechanism between two tape reels, as described above. Further, for example, it can be controlled by the control device of the magnetic recording and reproducing device or the like such that the minimum tension does not fall below a value determined or recommended by the standard or the like and/or the maximum value does not exceed a value determined or recommended by the standard or the like.

The recording of data on the magnetic tape is performed while the magnetic tape T is run between the tape reels 13A and 13B. The reproduction of data recorded on the magnetic tape is also performed while the magnetic tape T is run between the tape reels 13A and 13B.

As a temperature/humidity sensor 18, a well-known temperature/humidity sensor capable of measuring the relative humidity and temperature in the sealed space and transmitting a result of the measurement to an outside can be used.

After the recording and/or reproduction is ended, in one aspect, the magnetic tape T is stored in the magnetic recording and reproducing device until the next recording and/or reproduction is performed, in a state where the total length of the tape or most of the tape (for example, a portion having a length of 85% or more or 90% or more of the total length of the tape) is wound around any one of the tape reel 13A or the tape reel 13B. In another aspect, the magnetic tape T is stored in the magnetic recording and reproducing device until the next recording and/or reproduction is performed, in a case where a part of the magnetic tape (for example, a portion having a length of about 40% to 60% of the total length of the tape) is wound around the tape reel 13A and another portion of the magnetic tape is wound around the tape reel 13B.

### EXAMPLES

Hereinafter, one aspect of the present invention will be described based on Examples. Note that the present invention is not limited to the embodiments shown in Examples. “Parts” and “%” in the following description mean “parts by mass” and “mass %”, unless otherwise specified. “eq” indicates equivalent and is a unit not convertible into SI unit.

The following various steps and operations were performed in an environment of an atmosphere temperature of 20° C. to 25° C. and a relative humidity of 40% to 60%, unless otherwise noted.

[Ferromagnetic Powder]

In Table 1, “BaFe” in the row of the type of a ferromagnetic powder indicates a hexagonal barium ferrite powder having an average particle size (average plate diameter) of 21 nm.

In Table 1, “SrFe1” in the row of the type of a ferromagnetic powder indicates a hexagonal strontium ferrite powder produced by the following method.

1707 g of SrCO₃, 687 g of H₃BO₃, 1120 g of Fe₂O₃, 45 g of Al(OH)₃, 24 g of BaCO₃, 13 g of CaCO₃, and 235 g of Nd₂O₃ were weighed and mixed by a mixer to obtain a raw material mixture.

The obtained raw material mixture was melted in a platinum crucible at a melting temperature of 1390° C., and a hot water outlet provided at a bottom of the platinum crucible was heated while stirring a melt, and the melt was discharged in a rod shape at about 6 g/sec. Hot water was rolled and quenched by a pair of water-cooling rollers to produce an amorphous body.

280 g of the produced amorphous body was charged into an electric furnace, was heated to 635° C. (crystallization temperature) at a temperature rising rate of 3.5° C./min, and was kept at the same temperature for 5 hours to precipitate (crystallize) hexagonal strontium ferrite particles.

Next, a crystallized product obtained above including hexagonal strontium ferrite particles was coarsely pulverized in a mortar, and 1000 g of zirconia beads having a particle diameter of 1 mm and 800 mL of an acetic acid aqueous solution of 1% concentration were added to the crystallized product in a glass bottle, to be dispersed by a paint shaker for 3 hours. Thereafter, the obtained dispersion liquid was separated from the beads, to be put in a stainless beaker. The dispersion liquid was statically left at a liquid temperature of 100° C. for 3 hours and subjected to a dissolving treatment of a glass component, and then the crystallized product was sedimented by a centrifugal separator to be washed by repeatedly performing decantation and was dried in a heating furnace at an in-furnace temperature of 110° C. for 6 hours to obtain a hexagonal strontium ferrite powder.

The hexagonal strontium ferrite powder obtained above had an average particle size of 18 nm, an activation volume of 902 nm³, an anisotropy constant Ku of 2.2×10⁵ J/m³, and a mass magnetization σs of 49 A·m²/kg.

12 mg of a sample powder was collected from the hexagonal strontium ferrite powder obtained as described above, the element analysis of a filtrate obtained by the partial dissolving of this sample powder under the dissolving conditions described above was performed by the ICP analyzer, and a surface layer portion content of a neodymium atom was obtained.

Separately, 12 mg of a sample powder was collected from the hexagonal strontium ferrite powder obtained as described above, the element analysis of a filtrate obtained by the total dissolving of this sample powder under the dissolving conditions described above was performed by the ICP analyzer, and a bulk content of a neodymium atom was obtained.

A content (bulk content) of a neodymium atom with respect to 100 atom % of an iron atom in the hexagonal strontium ferrite powder obtained above was 2.9 atom %. A surface layer portion content of a neodymium atom was 8.0 atom %. It was confirmed that a ratio between a surface layer portion content and a bulk content, that is, “surface layer portion content/bulk content” was 2.8, and a neodymium atom was unevenly distributed in a surface layer of a particle.

The fact that the powder obtained above shows a crystal structure of hexagonal ferrite was confirmed by performing scanning with CuKα rays under conditions of a voltage of 45 kV and an intensity of 40 mA and measuring an X-ray diffraction pattern under the following conditions (X-ray diffraction analysis). The powder obtained above showed a crystal structure of hexagonal ferrite of a magnetoplumbite type (M type). A crystal phase detected by X-ray diffraction analysis was a single phase of a magnetoplumbite type.

PANalytical X'Pert Pro diffractometer, PIXcel detector

Soller slit of incident beam and diffraction beam: 0.017 radians

Fixed angle of dispersion slit: ¼ degrees

Mask: 10 mm

Anti-scattering slit: ¼ degrees

Measurement mode: continuous

Measurement time per stage: 3 seconds

Measurement speed: 0.017 degrees per second

Measurement step: 0.05 degrees

In Table 1, “SrFe2” in the row of the type of a ferromagnetic powder indicates a hexagonal strontium ferrite powder produced by the following method.

1725 g of SrCO₃, 666 g of H₃BO₃, 1332 g of Fe₂O₃, 52 g of Al(OH)₃, 34 g of CaCO₃, and 141 g of BaCO₃ were weighed and mixed by a mixer to obtain a raw material mixture.

The obtained raw material mixture was dissolved in a platinum crucible at a melting temperature of 1380° C., and a hot water outlet provided at a bottom of the platinum crucible was heated while stirring a melt, and the melt was discharged in a rod shape at about 6 g/sec. Hot water was rolled and quenched by a pair of water-cooling rollers to produce an amorphous body.

280 g of the obtained amorphous body was charged into an electric furnace, was heated to 645° C. (crystallization temperature), and was held at the same temperature for 5 hours to precipitate (crystallize) hexagonal strontium ferrite particles.

Next, a crystallized product obtained above including hexagonal strontium ferrite particles was coarsely pulverized in a mortar, and 1000 g of zirconia beads having a particle diameter of 1 mm and 800 mL of an acetic acid aqueous solution of 1% concentration were added to the crystallized product in a glass bottle, to be dispersed by a paint shaker for 3 hours. Thereafter, the obtained dispersion liquid was separated from the beads, to be put in a stainless beaker. The dispersion liquid was statically left at a liquid temperature of 100° C. for 3 hours and subjected to a dissolving treatment of a glass component, and then the crystallized product was sedimented by a centrifugal separator to be washed by repeatedly performing decantation and was dried in a heating furnace at an in-furnace temperature of 110° C. for 6 hours to obtain a hexagonal strontium ferrite powder.

The obtained hexagonal strontium ferrite powder had an average particle size of 19 nm, an activation volume of 1102 nm³, an anisotropy constant Ku of 2.0×10⁵ Jim′, and a mass magnetization σs of 50 A·m²/kg.

In Table 1, the “ε-iron oxide” indicates an ε-iron oxide powder produced as follows.

8.3 g of iron(III) nitrate nonahydrate, 1.3 g of gallium(III) nitrate octahydrate, 190 mg of cobalt(II) nitrate hexahydrate, 150 mg of titanium(IV) sulfate, and 1.5 g of polyvinylpyrrolidone (PVP) were dissolved in 90 g of pure water, and while the dissolved product was stirred using a magnetic stirrer, 4.0 g of an aqueous ammonia solution having a concentration of 25% was added to the dissolved product under a condition of an atmosphere temperature of 25° C. in an air atmosphere, and the dissolved product was stirred for 2 hours while maintaining a temperature condition of the atmosphere temperature of 25° C. A citric acid aqueous solution obtained by dissolving 1 g of citric acid in 9 g of pure water was added to the obtained solution and stirred for 1 hour. The powder precipitated after the stirring was collected by centrifugal separation, washed with pure water, and dried in a heating furnace at an in-furnace temperature of 80° C.

800 g of pure water was added to the dried powder, and the powder was dispersed again in water to obtain dispersion liquid. The obtained dispersion liquid was heated to a liquid temperature of 50° C., and 40 g of an aqueous ammonia solution having a concentration of 25% was dropwise added with stirring. After stirring for 1 hour while maintaining the temperature at 50° C., 14 mL of tetraethoxysilane (TEOS) was dropwise added and was stirred for 24 hours. A powder sedimented by adding 50 g of ammonium sulfate to the obtained reaction solution was collected by centrifugal separation, was washed with pure water, and was dried in a heating furnace at an in-furnace temperature of 80° C. for 24 hours to obtain a ferromagnetic powder precursor.

The obtained ferromagnetic powder precursor was placed into a heating furnace at an in-furnace temperature of 1000° C. in an air atmosphere and was heat-treated for 4 hours.

The heat-treated ferromagnetic powder precursor was put into an aqueous solution of 4 mol/L sodium hydroxide (NaOH), and the liquid temperature was maintained at 70° C. and was stirred for 24 hours, whereby a silicic acid compound as an impurity was removed from the heat-treated ferromagnetic powder precursor.

Thereafter, the ferromagnetic powder from which the silicic acid compound was removed was collected by centrifugal separation, and was washed with pure water to obtain a ferromagnetic powder.

The composition of the obtained ferromagnetic powder that was confirmed by high-frequency inductively coupled plasma-optical emission spectrometry (ICP-OES) has Ga, Co, and a Ti substitution type ε-iron oxide (ε-Ga_{0.28}Co_{0.05}Ti_{0.05}Fe_{1.62}O₃). In addition, X-ray diffraction analysis was performed under the same condition as described above for the hexagonal strontium ferrite powder SrFe1, and from a peak of an X-ray diffraction pattern, it was confirmed that the obtained ferromagnetic powder does not include α-phase and γ-phase crystal structures, and has a single-phase and ε-phase crystal structure (ε-iron oxide type crystal structure).

The obtained ε-iron oxide powder had an average particle size of 12 nm, an activation volume of 746 nm³, an anisotropy constant Ku of 1.2×10⁵ J/m³, and a mass magnetization σs of 16 A·m²/kg.

An activation volume and an anisotropy constant Ku of the above hexagonal strontium ferrite powder and ε-iron oxide powder are values obtained by the method described above using a vibrating sample magnetometer (manufactured by Toei Industry Co., Ltd.) for each ferromagnetic powder.

In addition, a mass magnetization as is a value measured at a magnetic field intensity of 1194 kA/m (15 kOe) using a vibrating sample magnetometer (manufactured by Toei Industry Co., Ltd.).

### Example 1

(1) Preparation of Alumina Dispersion

3.0 parts of 2,3-dihydroxynaphthalene (manufactured by Tokyo Chemical Industry Co., Ltd.), 31.3 parts of a 32% solution (solvent is a mixed solvent of methyl ethyl ketone and toluene) of a polyester polyurethane resin having a SO₃Na group as a polar group (UR-4800 manufactured by Toyobo Co., Ltd. (amount of a polar group: 80 meq/kg)), and 570.0 parts of a mixed solution of methyl ethyl ketone and cyclohexanone at 1:1 (mass ratio) as a solvent were mixed with respect to 100.0 parts of an alumina powder (HIT-80 manufactured by Sumitomo Chemical Co., Ltd.) having a pregelatinization ratio of about 65% and a Brunauer-Emmett-Teller (BET) specific surface area of 20 m²/g, and dispersed in the presence of zirconia beads by a paint shaker for 5 hours. After the dispersion, the dispersion liquid and the beads were separated by a mesh and an alumina dispersion was obtained.

(2) Formulation of Magnetic Layer Forming Composition

(Magnetic Liquid)

| | | |
|---|---|---|
| Ferromagnetic powder (see Table 1) | 100.0 | parts |
| SO₃Na group-containing polyurethane resin | 14.0 | parts |
| Weight-average molecular weight: | | |
| 70,000, SO₃Na group: 0.2 meq/g | | |
| Cyclohexanone | 150.0 | parts |
| Methyl ethyl ketone | 150.0 | parts |

(Abrasive Solution)

| | | |
|---|---|---|
| Alumina dispersion prepared in the section (1) | 6.0 | parts |

(Silica Sol (Protrusion Forming Agent Liquid))

| | | |
|---|---|---|
| Colloidal silica (average particle size: 120 nm) | 2.0 | parts |
| Methyl ethyl ketone | 1.4 | parts |

(Other Components)

| | | |
|---|---|---|
| Stearic acid | 2.0 | parts |
| Stearic acid amide | 0.2 | parts |
| Butyl stearate | 2.0 | parts |
| Polyisocyanate (CORONATE (registered trademark) | 2.5 | parts |
| L manufactured by Tosoh Corporation) | | |

(Finishing Additive Solvent)

| | | |
|---|---|---|
| Cyclohexanone | 200.0 | parts |
| Methyl ethyl ketone | 200.0 | parts |

(3) Formulation of Non-Magnetic Layer Forming Composition

| | | |
|---|---|---|
| Non-magnetic inorganic powder: α-iron oxide | 100.0 | parts |
| Average particle size (average long axis | | |
| length): 0.15 μm | | |
| Average acicular ratio: 7 | | |
| BET specific surface area: 52 m²/g | | |
| Carbon black | 20.0 | parts |
| Average particle size: 20 nm | | |
| SO₃Na group-containing polyurethane resin | 18.0 | parts |
| Weight-average molecular weight: | | |
| 70,000, SO₃Na group: 0.2 meq/g | | |
| Stearic acid | 2.0 | parts |
| Stearic acid amide | 0.2 | parts |
| Butyl stearate | 2.0 | parts |
| Cyclohexanone | 300.0 | parts |
| Methyl ethyl ketone | 300.0 | parts |

(4) Formulation of Back Coating Layer Forming Composition

| | | |
|---|---|---|
| Carbon black | 100.0 | parts |
| Dibutyl phthalate (DBP) oil absorption amount: | | |
| 74 cm³/100 g | | |
| Nitrocellulose | 27.0 | parts |
| Polyester polyurethane resin containing sulfonic | 62.0 | parts |
| acid group and/or salt thereof | | |
| Polyester resin | 4.0 | parts |
| Alumina powder (BET specific surface area: | 0.6 | parts |
| 17 m²/g) | | |
| Methyl ethyl ketone | 600.0 | parts |
| Toluene | 600.0 | parts |
| Polyisocyanate (CORONATE (registered trademark) | 15.0 | parts |
| L manufactured by Tosoh Corporation) | | |

(5) Preparation of Each Layer Forming Composition

The magnetic layer forming composition was prepared by the following method. The above magnetic liquid was prepared by dispersing each component for 24 hours (beads-dispersion) using a batch type vertical sand mill. As dispersion beads, zirconia beads having a bead diameter of 0.5 mm were used. Using the sand mill, the prepared magnetic liquid was mixed with the abrasive solution, and other components (silica sol, other components, and finishing additive solvent) and the mixture was beads-dispersed for 5 minutes, and then the treatment (ultrasonic dispersion) was performed on the mixture for 0.5 minutes by a batch type ultrasonic apparatus (20 kHz, 300 W). Thereafter, filtration was performed using a filter having a pore diameter of 0.5 μm to prepare a magnetic layer forming composition.

A non-magnetic layer forming composition was prepared by the following method. The components described above excluding the lubricant (stearic acid, stearic acid amide, and butyl stearate) were kneaded and diluted by an open kneader, and subjected to a dispersion treatment by a horizontal beads mill dispersing device. After that, the lubricant (stearic acid, stearic acid amide, and butyl stearate) was added into the obtained dispersion liquid and stirred and mixed by a dissolver stirrer to prepare a non-magnetic layer forming composition.

The back coating layer forming composition was prepared by the following method. The above components excluding polyisocyanate were introduced into a dissolver stirrer, stirred at a circumferential speed of 10 m/sec for 30 minutes, and then subjected to a dispersion treatment by a horizontal beads mill dispersing device. After that, polyisocyanate was added, and stirred and mixed by a dissolver stirrer, and a back coating layer forming composition was prepared.

(6) Method for Producing Magnetic Tape and Magnetic Recording and Reproducing Device

The non-magnetic layer forming composition prepared in the section (5) was applied onto a surface of a biaxially stretched polyethylene terephthalate support having a thickness of 4.1 μm so that the thickness after drying was 0.7 μm and was dried to form a non-magnetic layer. Next, the magnetic layer forming composition prepared in the section (5) was applied onto the non-magnetic layer so that the thickness after drying was 0.1 μm to form a coating layer. After that, while the coating layer of the magnetic layer forming composition is in an undried state, a vertical alignment treatment was performed by applying a magnetic field having a magnetic field intensity of 0.3 Tin a direction perpendicular to a surface of the coating layer, and then the surface of the coating layer was dried. Thereby, a magnetic layer was formed. After that, the back coating layer forming composition prepared in the section (5) was applied onto a surface of the support opposite to the surface on which the non-magnetic layer and the magnetic layer are formed and was dried so that the thickness after drying was 0.3 and thus, a back coating layer was formed.

After that, a surface smoothing treatment (calendering treatment) was performed using a calendar roll formed of only metal rolls at a speed of 100 m/min, a linear pressure of 300 kg/cm, and a calendar temperature of 90° C. (surface temperature of calendar roll).

After that, a long magnetic tape original roll was stored in a heat treatment furnace having an atmosphere temperature of 70° C. to perform a heat treatment (heat treatment time: 36 hours). After the heat treatment, the resultant was slit to have ½ inches width to obtain a magnetic tape. A servo signal was recorded on the magnetic layer of the obtained magnetic tape by a commercially available servo writer to obtain a magnetic tape having a data band, a servo band, and a guide band in an arrangement according to a linear tape-open (LTO) Ultrium format and having a servo pattern (timing-based servo pattern) in an arrangement and a shape according to the LTO Ultrium format on the servo band. The servo pattern thus formed is a servo pattern according to the description in Japanese industrial standards (JIS) X6175:2006 and Standard ECMA-319 (June 2001). The total number of servo bands is 5, and the total number of data bands is 4.

The magnetic tape (length of 970 m) after forming the servo pattern was wound around the winding core for heat treatment, and the heat treatment is performed while being wound around the winding core. As the winding core for heat treatment, a solid core member (outer diameter: 50 mm) formed of a resin and having the bending elastic modulus of 0.8 GPa was used, and the tension during winding was set as 0.6 N. The heat treatment was performed at a heat treatment temperature of 50° C. for 5 hours. The weight-basis absolute humidity in the atmosphere in which the heat treatment was performed was 10 g/kg Dry air.

After the heat treatment, the magnetic tape and the winding core for heat treatment were sufficiently cooled, the magnetic tape was removed from the winding core for heat treatment and wound around the temporary winding core, and then, the magnetic tape having the final product length (960 m) was wound around the tape reel (reel outer diameter: 44 mm) disposed in the magnetic recording and reproducing device in the following step from the temporary winding core. The remaining length of 10 m was cut out and the leader tape based on section 9 of Standard European Computer Manufacturers Association (ECMA)-319 (June 2001) Section 3 was bonded to the terminal of the cut side by using a commercially available splicing tape. As the temporary winding core, a solid core member made of the same material and having the same outer diameter as the winding core for heat treatment was used, and the tension during winding was set as 0.6 N.

As described above, the magnetic tape having a length of 960 m was wound around the tape reel.

In an environment of an atmosphere temperature and relative humidity (ambient environment during sealing) shown in Table 1, the magnetic recording and reproducing device of the configuration example shown in FIG. 3 was produced as follows.

In FIG. 3, the tape reel around which the magnetic tape was wound was installed as the tape reel 13A in FIG. 3 in the internal space S1 of the housing H1 covering the entire magnetic recording and reproducing device 10 in which the various components shown in FIG. 3 were already installed. In this state, after being placed in an ambient environment during sealing for 10 days or more, the housing H1 made of metal was sealed by the sealing means. A volume of the internal space S1 of the housing H1 was 3 L. As the temperature/humidity sensor disposed in the housing H1, a temperature/humidity data logger TR-72wb-S manufactured by T&D Corporation was used.

### Examples 2 to 7 and Comparative Example 1

A magnetic recording and reproducing device was produced in the same manner as in Example 1, except that the temperature and humidity of the ambient environment during sealing and one or more of the ferromagnetic powders used for forming the magnetic layer were changed as shown in Table 1.

### Example 8

A magnetic recording and reproducing device was produced in the same manner as in Example 1, except that a humidifying agent (ECOCARAT manufactured by LIXIL Corporation) was disposed in the housing H of the magnetic recording and reproducing device.

For each of Examples 1 to 8 and Comparative Example 1, the housing H1 was sealed by the sealing means after being placed in the ambient environment during sealing for 10 days or more, and then was left for 6 hours or longer to stabilize the temperature and humidity in the internal space S1. After that, the relative humidity and temperature in the internal space S1 of the housing H1 were measured by the temperature/humidity sensor. A result of the measurement is shown in the row of “Environment A near tape after sealing” in Table 1.

Since the housing H1 was sealed after being placed in the ambient environment during sealing for 10 days or more, it was confirmed that the environment A near the tape after the sealing had a temperature and humidity environment substantially the same as the ambient environment during sealing.

### Comparative Example 2

The tape reel was attached to a reel tester disposed in an open space without being accommodated in the magnetic recording and reproducing device. Evaluation of the recording and reproducing performance described below was performed in an open space using this reel tester.

[Measurement of Degree of Sealing]

For each of the magnetic recording and reproducing devices of Examples 1 to 8 and Comparative Example 1, a degree of sealing of the internal space S1 of the housing H1 was measured by a dipping method (bombing method) using helium (He) specified in JIS Z 2331:2006 helium leakage test method. As a result of the measurement, in any of the magnetic recording and reproducing devices, the degree of sealing of the internal space S1 of the housing H1 was 5×10⁻⁹ Pa·m³/sec or more and 10×10⁻⁸ Pa·m³/sec or less. From this result, in each of the magnetic recording and reproducing devices of Examples 1 to 8 and Comparative Example 1, it was confirmed that the internal space S1 of the housing H1 was a sealed space. For these Examples and Comparative Examples, “sealed” is indicated in the row of “system” in Table 1 described below.

In Comparative Example 2, since the magnetic tape was placed in an open space, “open” is indicated in the row of “system” in Table 1 described below.

[Measurement of Relative Humidity Difference (RH_{C}-RH_{B})]

The following measurement of the relative humidity was performed for Examples 1 to 8 and Comparative Example 1 using the temperature/humidity sensor disposed in the internal space S1 of the housing H1.

In Comparative Example 2, a temperature/humidity sensor (temperature/humidity data logger TR-72wb-S manufactured by T&D Corporation) was installed at a position within 30 cm from the tape reel around which the magnetic tape was wound, and the following measurement of the relative humidity was performed.

After being placed in an environment of an atmosphere temperature 21° C. and a relative humidity of 50% (hereinafter, referred to as “environment B”) for 6 hours or longer, a relative humidity RH_{B} was measured by the temperature/humidity sensor in the same environment, and the temperature was also measured.

Thereafter, after being placed in an environment of an atmosphere temperature 60° C. and a relative humidity of 5% (hereinafter, referred to as “environment C”) for 6 hours or longer, a relative humidity RH_{C} was measured by the temperature/humidity sensor in the same environment, and the temperature was also measured.

For each of Examples 1 to 8 and Comparative Examples 1 and 2, the relative humidity difference (RH_{C}-RH_{B}) was calculated.

[Evaluation of Recording and Reproducing Performance]

As a recording and reproducing head, a magnetic head having 32 channels of a reproducing element (reproducing track width of 1 μm) and a recording element and having servo signal reading elements on both sides (hereinafter, one is referred to as an upper side and the other is referred to as a lower side) thereof was used.

An atmosphere temperature of an environment for recording was set to 21° C. and a relative humidity thereof was set to 50%, and an atmosphere temperature of an environment for reproduction was set to 60° C. and a relative humidity thereof was set to 5%, and, each magnetic recording and reproducing device (in Comparative Example 2, a reel tester to which a tape reel around which a magnetic tape was wound was attached) was placed in each environment for 24 hours or longer.

During recording, pseudo random data having a specific data pattern was recorded on the magnetic tape by the recording and reproducing head unit while performing servo tracking. The tension applied in the longitudinal direction of the magnetic tape in this case was set to 0.56 N. For the recording of data, reciprocal recording of three or more times were performed such that a difference in value of (PES1+PES2)/2 between adjacent tracks was 1.1 μm.

During reproduction, data recorded on the magnetic tape was reproduced by the recording and reproducing head unit while performing servo tracking. The tension applied in the longitudinal direction of the magnetic tape in this case was set to 0.56 N.

PES1 and PES2 will be described below. “PES” is an abbreviation for “Position Error Signal”.

In order to obtain an interval between two servo bands adjacent to each other with the data band interposed therebetween, dimensions of the servo pattern are required. The standards of the dimensions of the servo pattern depend on the generation of LTO. First, an average distance AC between four stripes corresponding to an A burst and a C burst and an azimuth angle α of the servo pattern were measured by using a magnetic force microscope or the like.

Next, using the magnetic head, the servo patterns formed on the magnetic tape were sequentially read along the longitudinal direction of the tape. An average time between five stripes corresponding to the A burst and the B burst over a length of one LPOS word was defined as a. An average time between four stripes corresponding to the A burst and the C burst over a length of one LPOS word was defined as b. In this case, a value defined by AC×(½-a/b)/(2×tan(α)) represents a reading position PES in the width direction based on the servo signal obtained by the servo signal reading element over a length of one LPOS word. The reading of the servo pattern for one LPOS word was performed simultaneously by two servo signal reading elements on the upper side and the lower side. A value of PES obtained by the servo signal reading element on the upper side is referred to as PES1, and a value of PES obtained by the servo signal reading element on the lower side is referred to as PES2.

For the evaluation of the recording and reproducing performance, the recording and reproducing performance was evaluated as “3” in a case where all the data of 32 channels were correctly read, the recording and reproducing performance was evaluated as “2” in a case where data of 31 to 28 channels were correctly read, and the recording and reproducing performance was evaluated as “1” in other cases.

TABLE 1

| | | | | | | | | | | | Compar- | Compar- |
|---|---|---|---|---|---|---|---|---|---|---|---|---|
| | | | | | | | | | | | ative | ative |
| | | | Exam- | Exam- | Exam- | Exam- | Exam- | Exam- | Exam- | Exam- | Exam- | Exam- |
| | | | ple 1 | ple 2 | ple 3 | ple 4 | ple 5 | ple 6 | ple 7 | ple 8 | ple 1 | ple 2 |
| Ferromagnetic powder | | | BaFe | BaFe | BaFe | BaFe | SrFe1 | SrFe2 | ε-Iron | BaFe | BaFe | BaFe |
| | | | | | | | | | oxide | | | |
| System | | | Sealed | Sealed | Sealed | Sealed | Sealed | Sealed | Sealed | Sealed | Sealed | Open |
| Humidifying agent | | | Absent | Absent | Absent | Absent | Absent | Absent | Absent | Present | Absent | — |
| Ambient | Temperature | ° C. | 21° C. | 16° C. | 32° C. | 40° C. | 21° C. | 21° C. | 21° C. | 21° C. | 13° C. | — |
| environment | Relative | % | 50% | 50% | 60% | 10% | 50% | 50% | 50% | 50% | 50% | — |
| during sealing | humidity | | | | | | | | | | | |
| Environment A | Temperature | ° C. | 20° C. | 16° C. | 32° C. | 39° C. | 21° C. | 20° C. | 20° C. | 21° C. | 13° C. | — |
| near tape after | Relative | % | 51% | 48% | 58% | 8% | 49% | 50% | 48% | 48% | 49% | — |
| sealing | humidity | | | | | | | | | | | |
| Measurement | Temperature | ° C. | 20° C. | 19° C. | 20° C. | 20° C. | 22° C. | 21° C. | 21° C. | 22° C. | 20° C. | 21° C. |
| result in | Relative | % | 50% | 52% | 62% | 9% | 51% | 51% | 48% | 49% | 48% | 50% |
| environment B | humidity | | | | | | | | | | | |
| | RH_{B} | | | | | | | | | | | |
| Measurement | Temperature | ° C. | 58° C. | 59° C. | 61° C. | 60° C. | 60° C. | 58° C. | 61° C. | 58° C. | 58° C. | 60° C. |
| result in | Relative | % | 44% | 43% | 57% | 6% | 45% | 46% | 42% | 48% | 30% | 5% |
| environment C | humidity | | | | | | | | | | | |
| | RH_{C} | | | | | | | | | | | |

| | | | | | | | | | | |
|---|---|---|---|---|---|---|---|---|---|---|
| Relative humidity difference | −6% | −9% | −5% | −3% | −6% | −5% | −6% | −1% | −18% | −45% (open |
| (RH_{C} − RH_{B}) | | | | | | | | | | space) |
| Recording and reproducing | 2 | 2 | 3 | 3 | 2 | 3 | 2 | 3 | 1 | 1 |
| performance | | | | | | | | | | |

An aspect of the present invention is useful in the data storage technical fields.

What is claimed is:

1. A magnetic recording and reproducing device comprising, in a sealed space in the magnetic recording and reproducing device:
a magnetic tape; and
a magnetic head,
wherein a relative humidity difference, RH_{C}-RH_{B}, between a relative humidity RH_{B} in the sealed space measured in an environment of a temperature of 21° C. and a relative humidity of 50% and a relative humidity RH_{C} in the sealed space measured in an environment of a temperature of 60° C. and a relative humidity of 5% is within ±10%.

2. The magnetic recording and reproducing device according to claim 1,
wherein the relative humidity difference, RH_{C}-RH_{B}, is within ±5%.

3. The magnetic recording and reproducing device according to claim 1, further comprising, in the sealed space:
a humidity sensor.

4. The magnetic recording and reproducing device according to claim 2, further comprising, in the sealed space:
a humidity sensor.

5. The magnetic recording and reproducing device according to claim 1,
wherein the magnetic tape includes a non-magnetic support and a magnetic layer having a ferromagnetic powder.

6. The magnetic recording and reproducing device according to claim 5,
wherein the ferromagnetic powder is a hexagonal barium ferrite powder.

7. The magnetic recording and reproducing device according to claim 5,
wherein the ferromagnetic powder is a hexagonal strontium ferrite powder.

8. The magnetic recording and reproducing device according to claim 5,
wherein the ferromagnetic powder is an ε-iron oxide powder.

9. The magnetic recording and reproducing device according to claim 5,
wherein the magnetic tape further includes a non-magnetic layer containing a non-magnetic powder between the non-magnetic support and the magnetic layer.

10. The magnetic recording and reproducing device according to claim 5,
wherein the magnetic tape further includes a back coating layer containing a non-magnetic powder on a surface side of the non-magnetic support opposite to a surface side on which the magnetic layer is provided.

11. The magnetic recording and reproducing device according to claim 1,
wherein a tape thickness of the magnetic tape is 5.6 μm or less.

12. The magnetic recording and reproducing device according to claim 2,
wherein a tape thickness of the magnetic tape is 5.6 μm or less.

13. The magnetic recording and reproducing device according to claim 3,
wherein a tape thickness of the magnetic tape is 5.6 μm or less.

14. The magnetic recording and reproducing device according to claim 4,
wherein a tape thickness of the magnetic tape is 5.6 μm or less.

15. The magnetic recording and reproducing device according to claim 1,
wherein a tape thickness of the magnetic tape is 5.2 μm or less.

16. The magnetic recording and reproducing device according to claim 2,
wherein a tape thickness of the magnetic tape is 5.2 μm or less.

17. The magnetic recording and reproducing device according to claim 3,
wherein a tape thickness of the magnetic tape is 5.2 μm or less.

18. The magnetic recording and reproducing device according to claim 4,
wherein a tape thickness of the magnetic tape is 5.2 μm or less.
